(19) United States
(12) Patent Application Publication
(10) Pub. No.: US 2011/0184889 A1
(43) Pub. Date: Jul. 28, 2011

(54) Image forming system

(75) Inventors: Junichi Tokita, Kanagawa (JP); Kiichiroh Gotoh, Yokohama-shi (JP); Junichi Iida, Kawasaki-shi (JP); Takeshi Sasaki, Setagaya-Ku (JP); Masahiro Tamura, Kanagawa (JP); Satoshi Saito, Kawasaki-shi (JP); Ikuhisa Okamoto, Sagamihara-shi (JP); Shingo Matsushita, Ohta-Ku (JP); Takahiro Watanabe, Kanagawa (JP); Akira Kunieda, Tokyo (JP)

(73) Assignee: Ricoh Company, Limited, Tokyo (JP)

(21) Appl. No.: 12/929,348

(22) Filed: Jan. 18, 2011

(30) Foreign Application Priority Data
Jan. 27, 2010 (JP) 2010-015515

(51) Int. Cl. G06F 17/00; G06K 15/02

(52) U.S. Cl. 705/414; 705/400; 358/1.18; 358/1.2

(57) ABSTRACT

An image forming system includes: an image forming unit that forms an image on a sheet including a mail; a size recognizing unit that recognizes a size of the mail on which the image is formed by the image forming unit; and a postage calculating unit that calculates the postage of the mail, on the basis of a signal output from the size recognizing unit.

### CROSS-REFERENCE TO RELATED APPLICATIONS

The present application claims priority to and incorporates by reference the entire contents of Japanese Patent Application No. 2010-015515 filed in Japan on Jan. 27, 2010.

### BACKGROUND OF THE INVENTION

1. Field of the Invention

The present invention relates to an image forming system.

2. Description of the Related Art

In the related art, a paper processing device that is configured to automatically perform the work for packing paper (sheet) loaded on a paper loading unit such as a bin in an envelope has been known (for example, refer to Japanese Patent Nos. 3110804 and 3110806).

That is, Japanese Patent No. 3110804 discloses a technology related to the paper processing device in which the work for packing the paper loaded on the paper loading unit such as the bin in the envelope can be automatically performed with, superior operability. For the purpose of ensuring that the packed envelope is suitable for a paper size and looks nice, this paper processing device includes a paper loading unit that loads conveyed paper, a unit that carries the paper on the paper loading unit into the envelope, a paper size detecting unit that detects a size of the paper conveyed to the paper loading unit, an envelope size detecting unit that detects a size of the set envelop, an envelope size display unit that displays the size of the envelope detected by the envelope size detecting unit, a recognizing unit that recognizes a size of the envelope capable of storing the paper having the size detected by the paper size detecting unit, and a collating unit that collates the envelope size recognized by the recognizing unit and the envelope size detected by the envelope size detecting unit, and has an automatic envelope selection mode to automatically select an envelope having a minimum size among plural envelopes, when the plural envelopes having the sizes enabling the storage of the paper exist as the collation result obtained by the collating unit.

However, an image forming system that includes image forming devices and postprocessing devices developed until now, including those in the technologies disclosed in Japanese Patent Nos. 3110804 and 3110806, merely performs the work for packing the paper into the envelope. Specifically, the paper conveyed from the image forming device is loaded on a paper loading intermediate tray of a paper postprocessing device one by one, is aligned in a longitudinal direction or a lateral direction according to necessity, and is enclosed in an envelope enclosing section that exists at the downstream of the paper loading intermediate tray. In this paper processing device, sending a mail is not considered. For this reason, when sending a mail, a user is required to measure the weight, size, and thickness of the enclosed envelope and calculate postage.

### SUMMARY OF THE INVENTION

It is an object of the present invention to at least partially solve the problems in the conventional technology.

According to an aspect of the present invention there is provided an image forming system, including: an image forming unit that forms an image on a sheet including a mail; a size recognizing unit that recognizes a size of the mail on which the image is formed by the image forming unit; and a postage calculating unit that calculates the postage of the mail, on the basis of a signal output from the size recognizing unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating the schematic configuration of an image forming system according to an embodiment of the present invention, a size detecting system to detect, a size of paper or an envelope, and a control system;

FIG. 2 is a diagram illustrating the entire configuration of a digital copy machine and an SSP device constituting the image forming system of FIG. 1;

FIG. 3 is a perspective view illustrating a feed cassette that is mounted onto a feed section of the digital copy machine of FIG. 1;

FIG. 4 is a perspective view illustrating a state where the envelope is set on a tray of the digital copy machine of FIG. 1;

FIG. 5 is a side view of a size detecting device to detect the size of the envelope mounted onto the tray of FIG. 4;

FIG. 6 is a perspective view of a size measuring device including a CIS disposed on the tray of FIG. 4, when viewed from the upper side;

FIG. 7 is a block diagram illustrating a size detecting/measuring function based on the CIS;

FIG. 8 is a diagram illustrating a method of measuring a side end of the envelope or the paper using the CIS;

FIG. 9 is a plan view illustrating a flap of the envelope;

FIG. 10 is an enlarged front view of an SSP unit of the digital copy machine of FIG. 1;

FIG. 11 is a perspective view illustrating a positional relationship of a sort guide and a conveyance belt of the SSP unit;

FIG. 12 is a front view illustrating an aspect where the paper is discharged to the bin by the sort guide of the SSP unit;

FIG. 13 is a front view illustrating an aspect where the envelope is conveyed to an envelope chuck section in the SSP unit;

FIG. 14 is a front view illustrating an aspect where the envelope is conveyed to the envelope chuck section, following FIG. 13;

FIG. 15 is a front view illustrating a state where the envelope is held in the envelope chuck section such that an opening of the envelope is located lower than a lower end of an envelope opening mylar;

FIG. 16 is a front view illustrating a state where the lower end of the envelope opening mylar is entered into the envelope;

FIG. 17 is a perspective view illustrating a state where the envelope opening mylar is entered into the lower end of the envelope, similar to FIG. 16;

FIG. 18 is a perspective view illustrating a positional relationship of pack units provided in a pair in the SSP unit and a bin;

FIG. 19 is a side view illustrating a positional relationship of the pack unit and the bin;

FIG. 20 is a perspective view illustrating a main portion of the pack unit;

FIG. 21 is a plan view of the pack unit;

FIG. 22 is a perspective view illustrating a driving system that drives upper and lower rollers of the pack unit;

FIG. 23 is a diagram illustrating the configuration of a stapler that is provided in the SSP unit;

FIG. 24 is a perspective view illustrating a driving system that moves the SSP unit and the pack units;

FIG. 25 is a front view of a main portion illustrating a state where a bottom surface of the paper nipped by the pack units is lifted to the position higher than an upper end of a bin fence;

FIG. 26 is a front view illustrating an aspect where the pack units nip the paper and moves the paper to the insertion position in the envelope;

FIG. 27 is a front view illustrating an aspect where the paper nipped by the pack units is inserted into the envelope;

FIGS. 28A to 28C are front views illustrating the configuration of a weight measuring device and an operation transition of when the weight of the envelope is measured;

FIG. 29 is a block diagram illustrating a weight measuring section using a load cell;

FIG. 30 is a graph illustrating a relationship of an output voltage from the load cell and time;

FIG. 31 is a partially sectioned front view of a main portion illustrating the configuration of a thickness measuring device including an electronic micrometer;

FIGS. 32A to 32C are front views of a transition of a thickness measuring operation of the thickness measuring device;

FIGS. 33D and 33E are front views illustrating a transition of a thickness measuring operation subsequent to the operation of FIGS. 32A to 32C;

FIG. 34 is a block diagram illustrating the thickness measuring portion of the electronic micrometer;

FIG. 35A is a diagram illustrating output signals from the electronic micrometer;

FIG. 35B is a diagram illustrating results that are obtained by shaping waveforms of the output signals from the electronic micrometer in a signal processing portion in an SSP control board;

FIG. 36 is a plan view illustrating a main portion of an operation panel that is provided on the digital copy machine of FIG. 1;

FIG. 37 is a block diagram showing a control device to perform whole control of the image forming system of the copy machine in FIG. 1 and the SSP device and showing the association configuration thereof;

FIG. 38 is a flowchart illustrating determination of a mail system to calculate postage of the paper enclosed mail;

FIG. 39 is a flowchart illustrating calculation of the postage, when a mail is a postcard or a return postcard;

FIG. 40 is a plan view illustrating an example of marking an express delivery on the postcard; and

FIG. 41 is a flowchart illustrating determination of a mail system to calculate the postage, when an EXPACK500 is added.

### DETAILED DESCRIPTION OF THE PREFERRED EMBODIMENTS

Hereinafter, an embodiment of the present invention will be described in detail with reference to the accompanying drawings. In the embodiment, components (members or parts) having the same function and shape are denoted by the same reference numerals, as long as there is no fear of the confusion, and the description thereof is not repeated. In order to simplify the drawings and the description, the components that do not need to be specially described in a drawing among the components to be shown in the drawing may be omitted in the drawing.

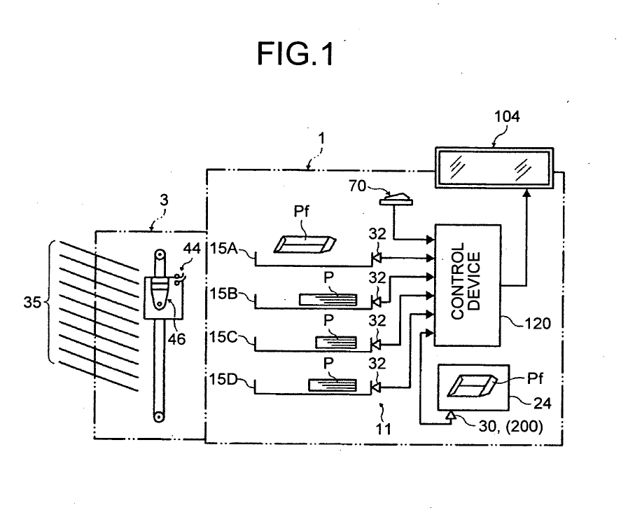

Referring to FIG. 1, an image forming system according to the embodiment of the invention will be described. FIG. 1 shows the schematic configuration of the image forming system according to the embodiment of the invention, a size detecting system to detect a size of paper or an envelope, and a control system to which a detection signal from the size detecting system is input. Hereinafter, in this embodiment, an “envelope” is mainly described as a mail object. A “postcard” that is also the mail object is described in a modification of the present embodiment. The hardware configuration of this embodiment uses a part of the configuration and the operation of the paper processing device of Japanese Patent Nos. 3110804 and 3110806 disclosed in the related art section.

The image forming system shown in FIG. 1 is composed of a system that includes a digital copy machine (hereinafter, also simply referred to as “copy machine”) 1 corresponding to an example of an image forming device and a sorter/stapler/packager device (hereinafter, also simply referred to as “SSP device”) 3 functioning as a postprocessing device mounted onto the sheet discharge side of a device body 1A in the digital copy machine 1.

The copy machine 1 functions as an image forming unit that can form an image on paper corresponding to a sheet including a mail (envelope, postcard, etc.) and convey the image formed mail (envelope, postcard, etc.) or paper.

The SSP device 3 includes paper loading bins (hereinafter, also simply referred to as “bins”) 35 that function as plural paper loading units (sheet loading units) to load the image formed envelope, postcard or paper P conveyed from the device body 1A, a sort guide section 44 serving as a sorting/discharging unit that sorts the paper P, which has been fed from a feed section 11 functioning as a paper (sheet) storage section of the device body 1A and on which an image has been formed, and discharges the paper P to the individual bins 35, and a pack unit 46 serving as a unit that carries the paper P on the bins 35 into an envelope Pf.

In the feed section 11, feed cassettes 15A to 15D and a tray 24 are disposed. The feed cassettes 15A to 15D and the tray 24 are configured such that the paper P and the envelope Pf or the postcard to be fed (not shown in the drawings) can be stored or set.

As described above, the sheet includes not only the paper but also all sheet-like recording media such as a mail (envelope or postcard), thick paper, or an OH film on which an image can be formed by the image forming unit. Therefore, the image forming unit is not limited to the copy machine 1 of an electrophotographic system according to this embodiment. For example, the image forming unit may be an image forming device, such as a single-color or full-color copy machine of an electrophotographic/magnetic recording system, an inkjet recording device, a printer including a stencil printer or a multifunctional device having two or more functions.

The copy machine 1 has size detecting sensors 32, a size detecting device 30 and a size measuring device 200, which is shown in FIG. 6, etc. and is described later, that perform both functions of a paper (sheet) size detecting unit and an envelope size detecting unit to detect sizes of the paper P, the envelope Pf, and the postcard (not shown in the drawings) fed from the feed cassettes 15A to 15D and the tray 24 of the feed section 11, a display section 104 (envelope size display unit) that functions as a mail size notifying unit or a mail size display unit to display the size of the mail such as the envelope or the postcard detected by a size detecting system, and a control device 120 that has the same function as that disclosed in Japanese Patent Nos. 3110804 and 3110806 for recognizing or determining the size of the envelope capable of storing the paper P having the size detected by each size detecting sensor 32, the size detecting device 30, or the size measuring device 200 shown in FIG. 6, etc. and collating the determined size of the envelope and the size of the envelope detected by the size detecting sensor 32 or the size detecting device 30 and various functions peculiar to the present embodiment and described later.

In FIG. 1, reference numeral 70 denotes a main switch that switches connection and disconnection of a main power supply.

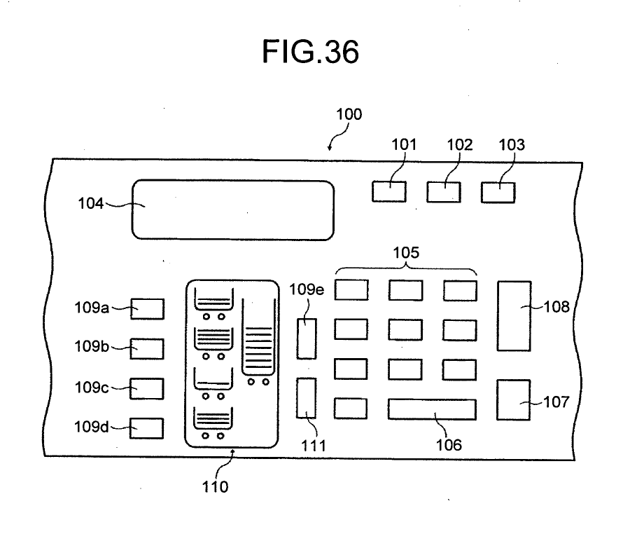

The copy machine 1 that is described in detail later includes an operation panel 100 (refer to FIG. 36) that functions as an operation section including a ten key 105, etc. functioning as a sheet number setting unit to set/input (hereinafter, simply referred to as “set”) the number of paper to be enclosed in the envelope. When an “envelope enclosing mode” where the paper is enclosed in the envelope is selected, the control device 120 functions as a used envelope selecting unit that selects an envelope to be used from envelopes having the recognized/determined size capable of storing set number of paper having the size detected by the size detecting sensor 32, the size detecting device 30 or the size measuring device 200 shown in FIG. 6, etc. When the set number of paper exceeds the recognized/determined number of paper, the control device 120 releases the “envelope enclosing mode”. After that, when the “envelope enclosing mode” is selected, the control device 120 controls the display section 104 to display a screen for allowing the number of paper to be enclosed in the envelope to be set.

Here, the size detecting sensor 32, the size detecting device 30, and CISs 201 and 202 of the size measuring device 200 shown in FIG. 6, etc. and described later function as a size detecting unit to detect the size of the mail or the paper and a size measuring unit to measure the size of the mail or the paper. The size recognizing unit that recognizes the size of the mail includes a size setting unit to manually se the size of the mail, in addition to the size detecting unit and the size measuring unit. Specifically, the size setting unit include an example in which the size of the mail is manually set using a ten key 105, an enter key 107, and the display section 104 that are disposed in the operation panel 100 shown in FIG. 36 described later. This way, in this embodiment, the plural size detecting units are provided.

The control device 120 that is described in detail later has a function as a postage calculating unit (broadly-defined) that calculates the postage of the mail, on the basis of signals indicating the size, weight, and thickness of the mail output from the size recognizing unit to recognize the size of the mail on which the image is formed by the copy machine 1 according to this embodiment, a weight recognizing unit to recognize the weight of the mail, and a thickness recognizing unit to recognize the thickness of the mail, described later.

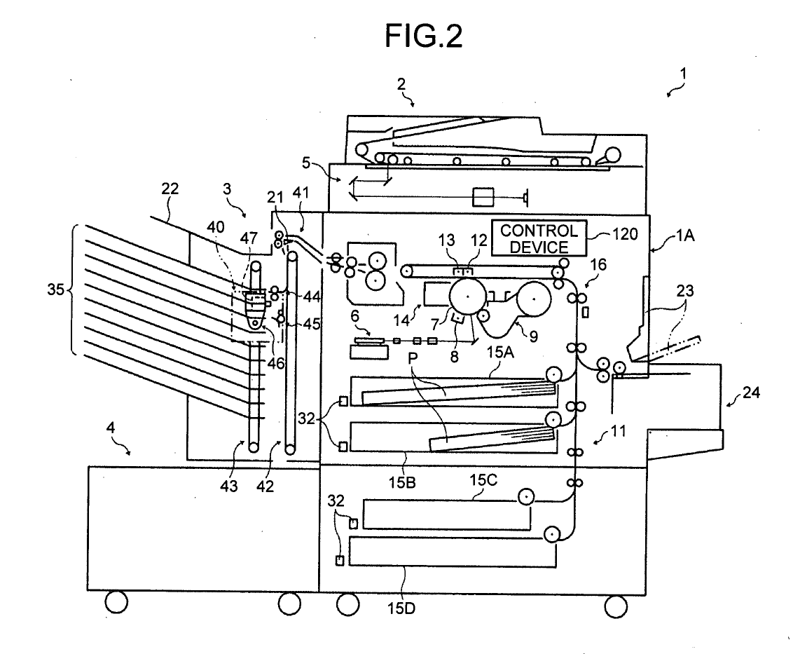

In this embodiment, the envelope in which at least one paper (sheet) on which an image is formed is enclosed as contents of a mail capable of being mailed is explained. An enclosing unit or an enclosing mechanism that enclose at least one paper (sheet) to the envelope mainly include an envelope chuck section 45 shown in FIGS. 2, 6, 10, etc. and a pack unit 46 that is shown in FIGS. 1, 2, 6, 10, etc., described later, of the SSP device 3 (narrowly-defined configuration).

The display section 104 functions as a first notifying unit or a first display unit that notifies/displays the postage calculated by the control device 120 having the function as the postage calculating unit. The display section 104 also functions as a second notifying unit or a second display unit that notifies weight data recognized by an weight recognizing unit described later. The display section 104 also functions as a third notifying unit or a third display unit that, when the postage cannot be calculated by the control device 120, notifies accordingly.

In this case, the first to third notifying units include a display unit such as the display section 104 that is composed of a liquid crystal display (LCD) or a light emitting diode (LED) that is recognized by a human visual sense, as well as a unit that is recognized by a human acoustic sense based on a voice or blowing or warning of a buzzer (this also applies to each notifying unit described later).

Referring to FIG. 2, the entire configuration of the image forming system that encloses the paper in the envelope and the configuration as well as the configuration and the operation of a main portion of the copy machine 1 will be described. As shown in FIG. 2, in the copy machine 1, a recirculating document handler (RDH) 2 is mounted above the device body 1A, the SSP device 3 that is a postprocessing device is attached to at an upper portion of a left side of the device body 1A, and a storage carrier 4 that stores the envelope in which the paper is enclosed is attached to a lower portion of the SSP device 3.

In the copy machine 1 shown in FIG. 2, image information after subjected to image processing by an image scanning section 5 is written in a photosensitive drum 7 functioning as an image carrier in a form of a set of light spots, by raster scanning of a laser beam with a writing section 6. A semiconductor laser is used as a laser light source for the laser beam.

A surface of the photosensitive drum 7 is uniformly negatively charged by an electric charger 8 of a corotron system. When the laser beam illuminates the negatively charged photosensitive drum 7 and the potential of an image portion thus illuminated decreases, an electrostatic latent image where the potential of a background portion is −750 to −800 V and the potential of an image portion is about −50 V is formed on the surface of the photosensitive drum 7.

The electrostatic latent image is developed by a toner negatively charged by applying a bias voltage of −500 to −600 V by a developing roller of a developer 9. The developed image is transferred to the surface of the paper (transfer paper) P that is fed from the feed section 11 and is timed with the rotation of the photosensitive drum 7, by applying charges of the positive potential from the back side of the paper by a transfer charger 12.

The paper on which the image is transferred is neutralized by alternating current with a separation charger 13 held integrally with the transfer charger 12 and thus the paper is separated from the surface of the photosensitive drum 7. At this time, the toner that remains on the photosensitive drum 7 is scraped from the surface of the photosensitive drum 7 by a cleaning blade (not shown in the drawings) of a cleaning device 14 and is stored in a collection tank (not shown in the drawings). The potential that remains on the surface of the photosensitive drum 7 is removed by illumination of light using a neutralization lamp (not shown in the drawings).

Meanwhile, the paper P on which the image is transferred is selectively fed from one of four steps of the feed cassettes 15A to 15D provided in the feed section 11, according to the size of the paper. That is, if the feed cassette at one of the feed steps is selected by an operator and a start key 108 (refer to FIG. 36) is pressed, a feed roller that functions as a sheet feed unit of the selected feed step rotates and the paper in the feed cassette is fed. The fed paper is fed until the paper bumps into a nip of a resist roller 16 by rollers functioning as sheet conveying unit provided at plural places (not shown in the drawings) on a sheet conveyance path.

The resist roller 16 feeds the paper to the photosensitive drum 7 at such timing that the position of the image formed on the photosensitive drum 7 and the position of the paper are matched with each other.

In this way, the paper P is fed, the image is transferred to the paper by the abovementioned method, and the image (toner image) is fixed by a fixing roller. The paper P on which the image is fixed is fed to the SSP device 3. In normal printing, the paper P is guided by a switching claw that is switched to a position of a straight advancement state and thus is discharged to a discharge tray 22.

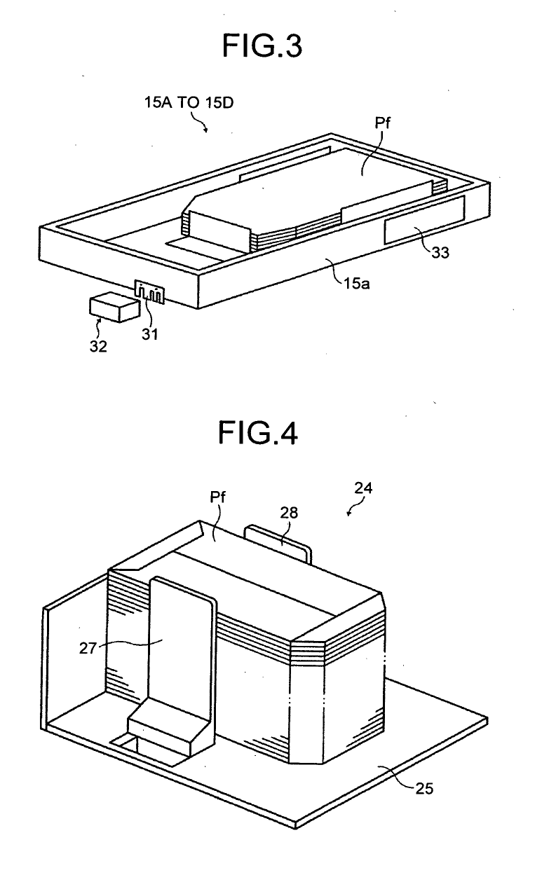

Referring to FIGS. 3 to 5, a feeder that feeds the envelope, etc. will be described. FIG. 3 is a perspective view illustrating the feed cassettes 15A to 15D of the feed section 11 shown in FIGS. 1 and 2 and a size detecting system (size detecting unit) functioning as both the paper size detecting unit the envelope size detecting unit.

To each of the feed cassettes 15A to 15D of the feed section 11, a size indication plate 31 that is formed to correspond to the size of stored paper or the size of stored envelope is attached. When the feed cassettes are set to the device body, the size detecting sensor 32 that is provided at the device body to correspond to the size indication plate 31 detects the sizes of the paper or the envelope as the mail (envelope Pf is set/stored in FIG. 3) stored in the feed cassettes by detecting the size indication plate 31.

A size sticker 33 by which the size of the paper or the envelope as a storage material stored in the feed cassette is displayed is bonded to a side 15a of each of the feed cassettes 15A to 15D, so that a user can know the size of the storage material stored in the feed cassette at one view.

The feed of the paper in the copy machine 1 can also be made from a manual tray 23 that is disposed on the right side of the device body 1A in FIG. 2 and can be opened and closed at the position shown by a solid line and a virtual line as well as from a tray 24 that is provided below the manual tray 23.

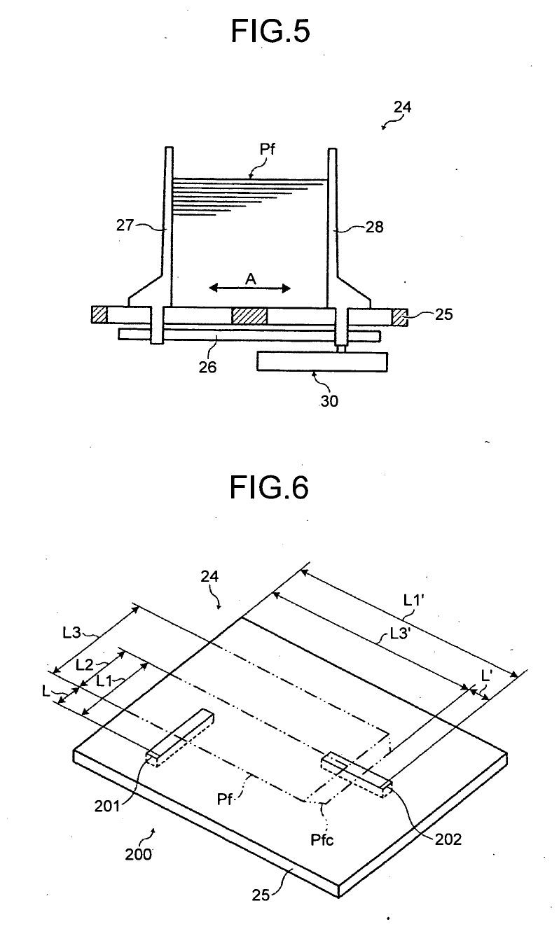

As shown in FIGS. 4 and 5, the tray 24 is configured to be able to store larger number of the paper or the envelopes than that can be stored in the feed cassettes 15A to 15D. In the tray 24, the envelope Pf is loaded on a bottom plate 25, and is nipped by a pair of side guides 27 and 28 slidable in a direction of an arrow A along a guide rod 26 shown in FIG. 5 to be set at the central position of the bottom plate 25.

Below the bottom plate 25, the size detecting device 30 (for example, composed of a known variable resistance type position sensor) that detects the position of the side guide 28 to detect the size of the paper or the envelope loaded on the bottom plate 25 is disposed. The size of the paper or the envelope Pf shown in the drawing set on the bottom plate 25 can be detected and recognized by comparing a value detected by the size detecting device 30 with size data previously stored in a ROM 132 of a main control board 130 described later constituting the control device 120.

Referring to FIGS. 6 to 9, a size measuring device 200 that may replace the size detecting device 30 will be described. FIG. 6 is an exterior perspective view of the tray 24 in which the size measuring device 200 is mounted on the bottom plate 25. The size of the envelope or the paper can be accurately measured by using a contact image sensor (hereinafter, simply referred to as “CIS”) composed of a CCD image sensor, instead of the size detecting device 30.

Hereinafter, it is assumed that the size measuring device 200 is provided in the tray 24 to measure the size of the envelope or the paper.

As shown in FIG. 6, two CISs 201 and 202 are used in the size measuring device 200 to measure longitudinal and lateral sizes of the envelope Pf shown by a virtual line or the paper. The CISs 201 and 202 are mounted onto a lower portion of the bottom plate 25, and the CIS 201 is used to measure the lateral size of the envelope Pf and the CIS 202 is used to measure the longitudinal size of the envelope Pf. The CISs 201 and 202 measure only the side end of the envelope Pf or the paper. However, the CISs 201 and 202 may measure a whole surface.

Each of the CISs 201 and 202 functions as a size recognizing unit that recognizes the size of the envelope Pf corresponding to the mail, a size measuring unit that measures the same size or a size detecting unit.

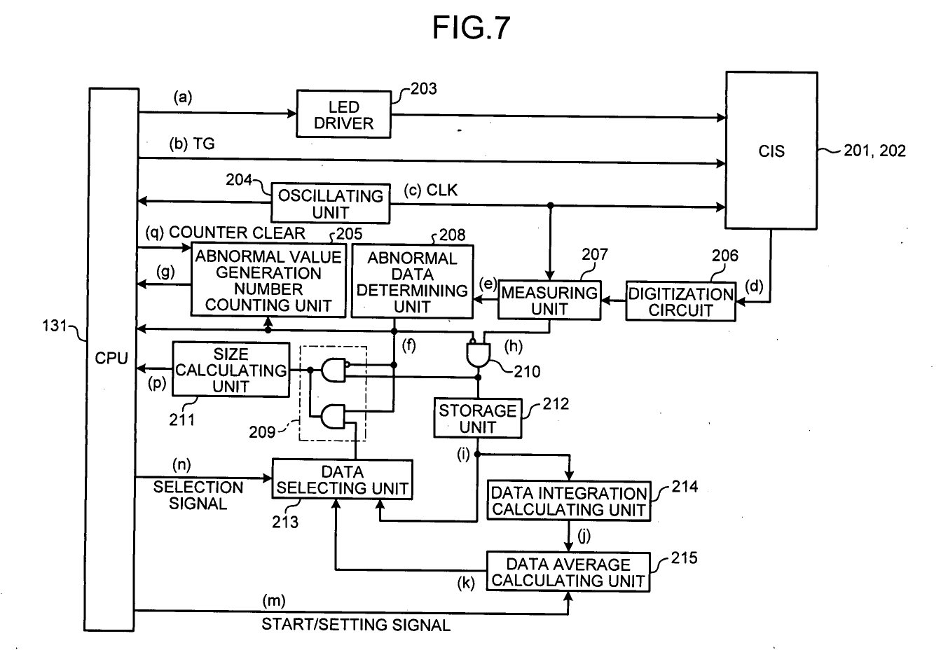

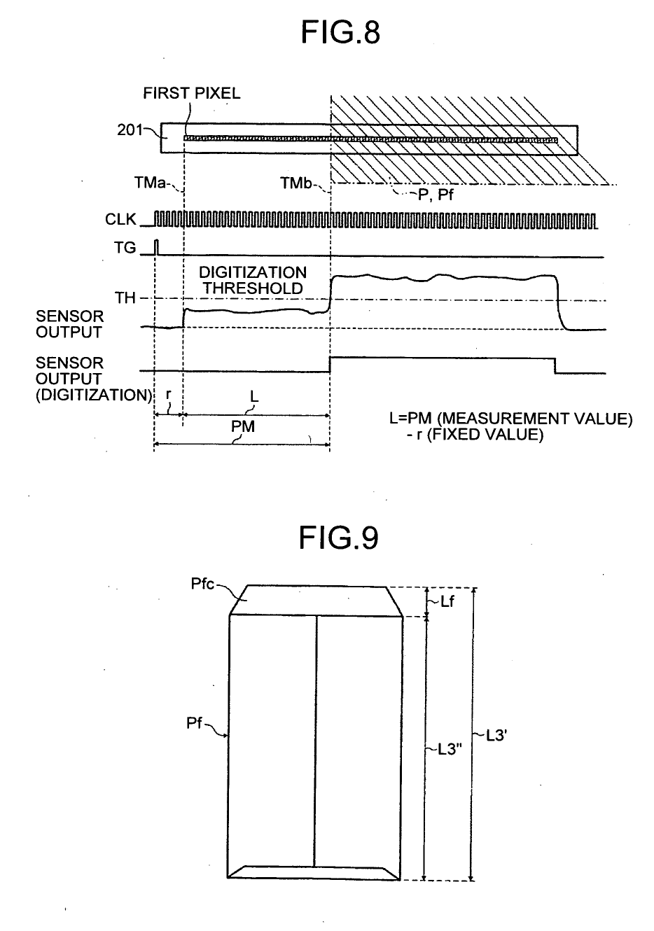

Referring to FIGS. 7 and 8, a detailed size measuring method in the case where the side end of the envelope Pf or the paper is measured using the CIS will be described. FIG. 7 is a block diagram of a size detecting/measuring function of measuring the side end of the envelope or the paper using the CIS and FIG. 8 is a diagram illustrating a method of measuring the side end of the envelope or the paper using the CIS.

Since the methods of measuring the size of the envelope or the paper using the CIS 201 and the CIS 202 are the same, the CIS 201 and the CIS 202 are described as the CIS as a whole. As shown in FIG. 7, the size of the envelope or the paper is detected by a CPU 131 in the control device 120. The control device 120 outputs a control signal (a) of an LED driver 203 and a trigger signal TG (b) to start measurement to the CISs (201 and 202, which are omitted hereinafter), and controls a clock oscillating unit 204 oscillating a clock to output a clock (c).

An analog output (d) of the CIS is digitized by a digitization circuit 206 and is input to a paper end position measuring unit (hereinafter, simply referred to “measuring unit”, also in FIG. 7) 207. The measuring unit 207 measures the number of clocks (CLK) until a HIGH level edge corresponding to a paper end including an envelope end to measure the paper position including the envelope position. The measurement result is input to an abnormal data determining unit 208 as an output (e). When the position based on the obtained data is greatly deviated from the position based on the paper size or the envelope size detected by the size detecting device 30 or the paper end cannot be detected, the abnormal data determining unit 208 determines abnormality and outputs an abnormal signal (=1 at the time of abnormality) (f) to each of gate circuit 209, the CPU 131, and an abnormal value generation number counting unit 205.

The abnormal value generation number counting unit 205 can count the number of times the abnormal signal (f) is output from the abnormal data determining unit 208. An output (g) from the abnormal value generation number counting unit 205 is transmitted to the CPU 131 and counter contents are cleared by a counter clear signal (q) from the CPU 131. An output (h) from the measuring unit 207 is stored in a storage unit 212 by a gate circuit 210, when the data is normal (output of the abnormal data determining unit 208 is 0). When the output is stored, the output may be stored while being sorted by the envelope size or the paper size, or being sorted by JOB content.

A start/setting signal (m) is output to a data average calculating unit 215 according to an instruction from the CPU 131 so that an average (k) is calculated by the data average calculating unit 215 after necessary pieces of data (i) in the storage unit 212 is integrated by a data integration calculating unit 214 (j). A size calculating unit 211 is provided to calculate the envelope size or the paper size. With respect to an input (p) of the size calculating unit 211, when data is not abnormal data, a result (e) of the measuring unit 207 is input from the gate circuit 209, and when the data is the abnormal data, data that is selected by a data selecting unit 213 on the basis of a selection signal (n) from the CPU 131 is input. The position of the paper end including the envelope end is calculated by the size calculating unit 211 on the basis of the above input, and a result (end position data (p)) is output to the CPU 131. The CPU 131 can recognize/determine the size of the envelope or the paper, on the basis of the end position data (p) input from the size calculating unit 211.

Referring to FIG. 8, a specific example of the method of detecting the lateral size of the envelope Pf or the paper P by the CIS 201 will be described. FIG. 8 shows a detection state of the envelope Pf or the paper P by the used CIS 201. The end face of the envelope Pf or the paper P is calculated by detecting the distance shown as L by the CIS 201.

To the CIS 201, the clock (CLK) is input and the trigger signal (TG) to start measurement is applied so that the measurement is started. Then, an output for each pixel of the CIS 201 is made for each one clock stated from the first pixel after a predetermined number of clocks (r in the drawing). As reflectance of the envelope Pf or the paper P increases, a level of the sensor output increases. Therefore, if an analog output of the sensor is digitized with an appropriate threshold level (digitization threshold (TH) in the drawing), an output can be digitized according to whether the envelope Pf or the paper P exists. In an example of FIG. 8, in a range (TMa) to (TMb) where the envelope Pf or the paper P does not exist, since the sensor output is low, the digitized output becomes a LOW level. In a range (TMb) after a position where the envelope Pf or the paper P exists, since the level of the sensor output is higher than the threshold level, the digitized output becomes a HIGH level. The position of the envelope Pf or the paper P can be detected by measuring PM in the drawing by counting the clock number or measuring a time until the digitized output from the trigger signal (TG) becomes a HIGH level (TMb).

That is, since the position of the end face of the envelope Pf or the paper P corresponds to the position corresponding to the (TMb) from the first pixel of the CIS 201, the position can be calculated by the following equation (1).

L=PM−r (1)

The calculated L corresponds to L in FIG. 6. Since L1 in FIG. 6 is a fixed value fixed according to the layout of the CIS 201 and the bottom plate 25, the length L3 of the envelope Pf or the paper P in a lateral direction in FIG. 6 is calculated by the following equation (2).

L3=L2×2=(L1−L)×2 (2)

In the same way as described above, since L′ can be measured by the CIS 202, the length L3′ in a longitudinal direction can be calculated by the following equation (3).

L3′=L1′−L′ (3)

Referring to FIG. 9, the flap Pfc (a bonding allowance, a covering lid) of the envelope Pf will be described. The length Lf (hereinafter, referred to as “flap length Lf”) of the flap Pfc in the envelope Pf may be freely set by the user, etc. and may be changed according to the number of paper enclosed in the envelope Pf at the time of enclosing. From this viewpoint, the exact longitudinal length L3″ of the envelope Pf can be obtained using the length Lf of the flap Pfc set by the user using the operation panel 100 in FIG. 3 described later.

From the flap length Lf set by the user using, for example, the ten key 105 and the enter key 107 disposed on the operation panel 100 in FIG. 36 and from the envelope length L3′ obtained by the CIS 202, the longitudinal length L3″ of the envelope Pf shown in FIG. 9 can be calculated by the following equation (4).

L3″=L3′−Lf (4)

In this case, the ten key 105 and the enter key 107 of the operation panel 100 function as a length setting unit to set the flap length Lf of the envelope Pf.

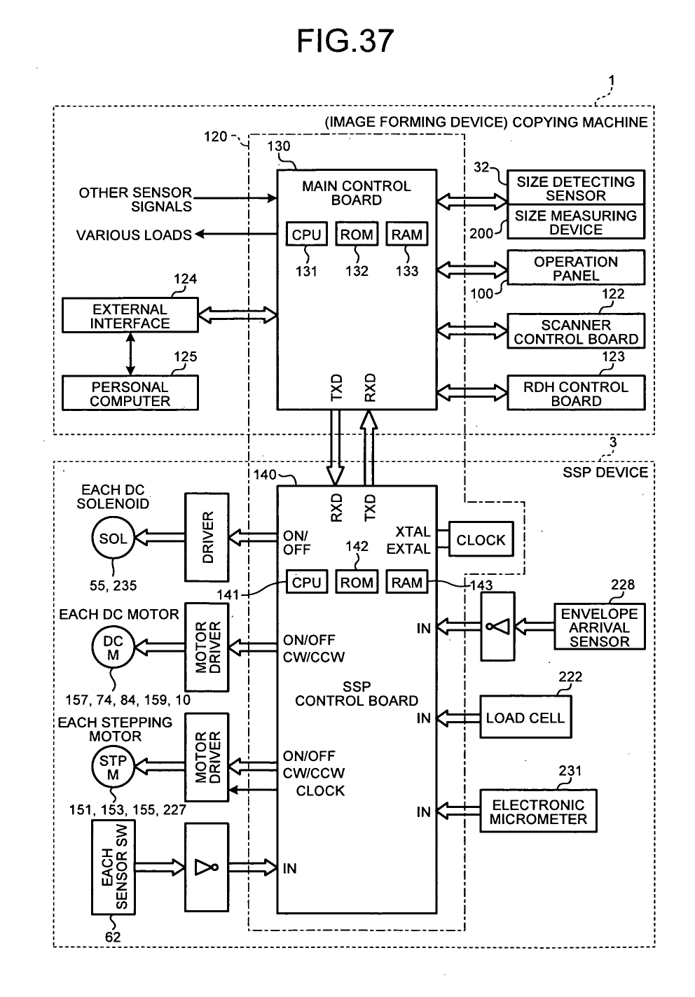

The representative envelope size and the envelope size that is optionally set or input by the user may be previously registered in the ROM 132 of the main control board 130 constituting the control device 120 in FIG. 37 described later so that it is possible to save the user trouble of setting/inputting the flap length Lf of the envelope Pf.

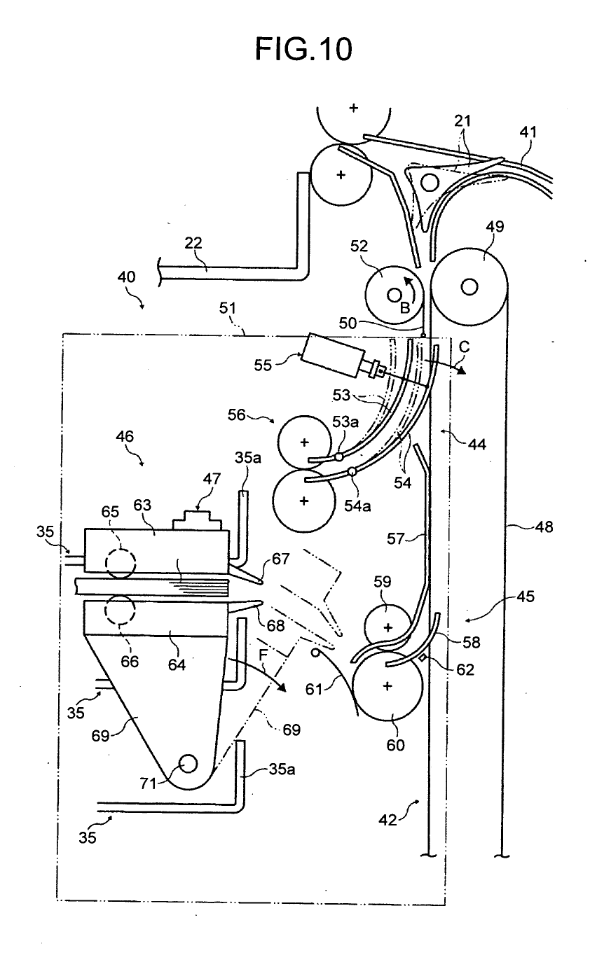

Referring to FIG. 10, an enclosing device including an enclosing unit that encloses at least one paper in the envelope will be described.

The SSP device 3 that functions as a postprocessing device and is shown in FIG. 2 fulfills functions such as discharging the paper, on which the image is formed and which is discharged from the device body 1A shown in FIG. 2, to the discharge tray 22, sorting the paper, etc. according to the selected mode to discharge the paper, etc. to the individual bins 35 disposed in the multiple steps, binding the paper, etc. by a stapler 47, and enclosing the paper into the envelop.

The SSP device 3 includes plural paper, loading bins 35 to load the paper, a horizontal conveyance path 41 to discharge the paper, etc. discharged from the device body 1A to the discharge tray 22, a vertical conveyance path 42 to convey the paper downwardly, the envelope (or postcard), etc. guided downwardly by the switching claw 21 provided on the horizontal conveyance path 41, and an SSP unit 40 to selectively discharge the paper fed to the vertical conveyance path 42 to the bins 35.

The SSP unit 40 is elevated between, the bins, by an elevating device 43 including a motor, upper and lower pulleys, and a driving belt stretched between the upper and lower pulleys described later. The SSP unit 40 includes a sort guide section 44 that functions as a sorting/discharging unit to sort the paper p on which the image is formed in the device body 1A shown in FIG. 2 to discharge the paper p to bins 35 as shown in FIG. 10, a pack unit 46 that is a unit to be provided below the sort guide section 44 and carry the paper (not shown in the drawings) loaded on the bin 35 into the envelope held by the envelope chuck section 45, and the stapler 47 that is mounted integrally with the pack unit 46.

Here, the SSP unit 40 functions as an enclosing unit or an enclosing mechanism that encloses the mail contents such as the mailable paper in the envelope (broadly-defined enclosing unit). As described above, the narrowly-defined enclosing unit or enclosing mechanism mainly include the envelope chuck section 45 that is shown in FIGS. 2, 6, and 10 and the pack unit 46 that is shown in FIGS. 2, 6, and 10.

The vertical conveyance path 42 is configured using a conveyance belt 48 that is rotatably stretched between the upper and lower pulleys 49 (the lower side is not viewed in FIG. 10), and an extension belt 50 is provided to extend along the conveyance belt 48. In the extension belt 50, one end is fixed to an upper end of a frame 51 of the SSP unit 40 and the other end is fixed to a winding roller 52 rotatably mounted onto a fixed portion of the device body in the SSP device 3. The extension belt 50 is wound by rotation of the winding roller 52 in a direction of an arrow B.

The winding roller 52 is always biased by a spring (not shown in the drawings) in the direction of the arrow B in which the extension belt 50 is wound, the extension belt 50 is delivered or wound according to the vertical movement of the SSP unit 40, the predetermined tension is always applied to the extension belt 50 so that the extension belt 50 is not loosened, and the vertical conveyance path 42 is formed between the conveyance belt 48 and the extension belt 50.

Referring to FIGS. 10 to 13, the sort guide section 44 will be described. In FIGS. 10 and 12, the sort guide section 44 is a device that sorts the paper P to each bin 35. Swing support portions 53a and 54a are formed in the vicinity of lower ends of a pair of sort guides 53 and 54 made of thin plate members formed in an arc shape so that movable guide portions that are portions of the sort guide section 44 located above the swing support portions 53a and 54a are configured to be swingable in a direction of an arrow C. A movable shaft of a solenoid 55 is attached to the movable guide portions so that the movable guide portions are moved to the position shown by a virtual line in FIG. 10 when the solenoid 55 is turned on.

Respective ends of the pair of the sort guides 53 and 54 that are located under the swing support portions 53a and 54a are fixed to the frame 51 and a discharge roller pair 56 is inserted in a cut groove formed at the ends sort guides 53 and 54 without interference therewith.

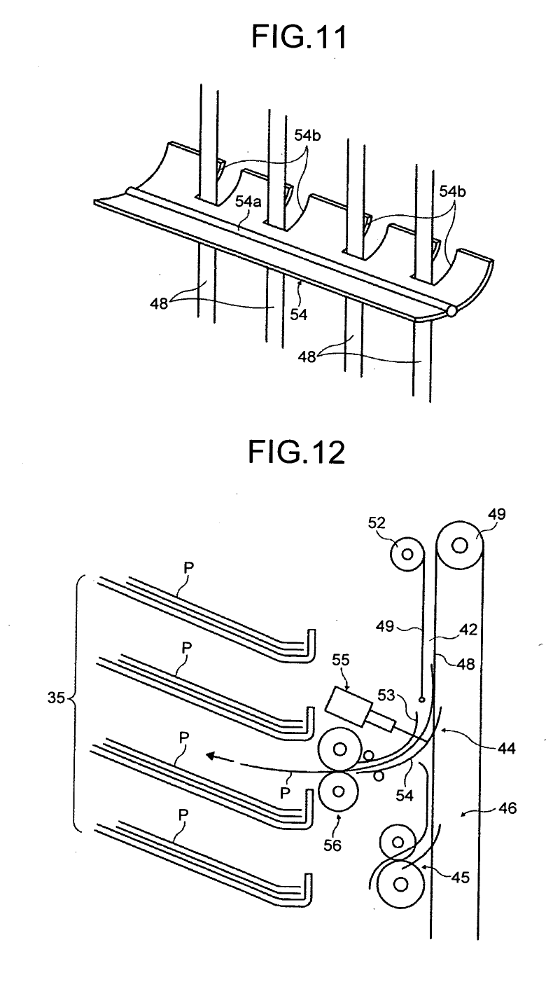

As shown in FIG. 11, in the lower sort guide 54, notch grooves 54b that respectively receive the plural conveyance belts 48 disposed at an approximately equivalent interval in an anteroposterior direction without interference therewith. As a result, driving of the conveyance belt 48 is not affected even when the sort guide 54 is positioned at the position shown by a solid line in FIG. 10.

In the sort guide section 44, when the paper P is sorted to each bin 35, the solenoid 55 is in the off state. Therefore, as shown in FIG. 12, the paper P that is conveyed downwardly by the conveyance belt 48 of the vertical conveyance path 42 is fed between the sort guide pair 53 and 54 at the position shown in the drawing, and is discharged to the bin 35 designated by the discharge roller pair 56.

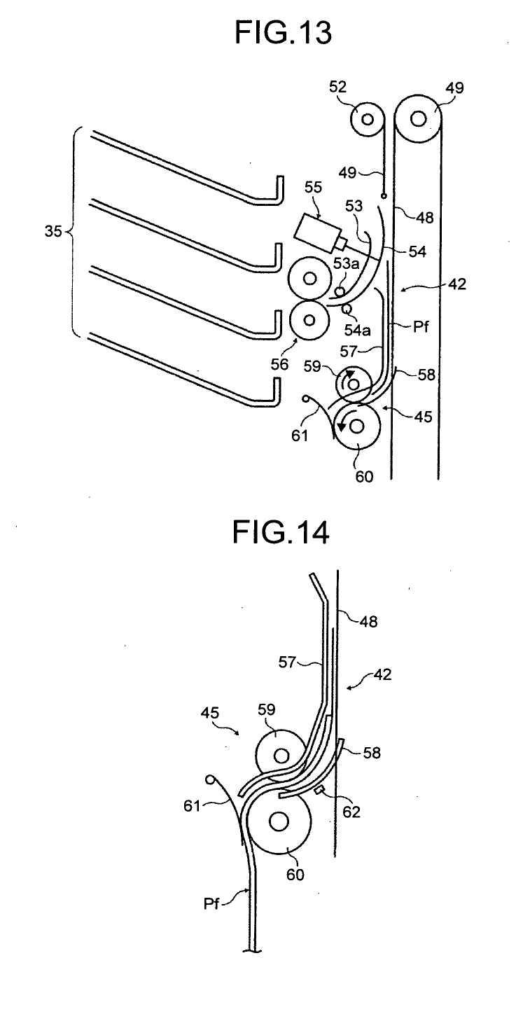

Meanwhile, when the paper that is conveyed to the vertical conveyance path 42 is the envelope Pf and the envelope is conveyed to the envelope chuck section 45, the solenoid 55 becomes an on state. Therefore, as shown in FIG. 13, the sort guides 53 and 54 are swigged about the swing support portions 53a and 54a to the position shown in FIG. 13 to be moved away from the vertical conveyance path 42, and the vertical conveyance path 42 to convey the envelope Pf downwardly is formed by the back surface (bottom surface) of the lower sort guide 54 and the conveyance belt 48. Therefore, the envelope Pf that is conveyed downwardly along the vertical conveyance path 42 is conveyed to the envelope chuck section 45 by the conveyance belt 48.

Referring to FIGS. 14 to 17, the envelope chuck section 45 will be described. As shown in FIG. 14, the envelope chuck section 45 mainly includes a pair of chuck rollers 59 and 60 (they may be rollers) that can contact to be forced toward one another in a vertical direction and rotate, a pair of envelope guides 57 and 58 that guide the envelope Pf to a nip portion of the chuck roller pair 59 and 60, an envelope detecting sensor 62 that is disposed on the conveyance at the upstream of the nip portion of the chuck roller pair 59 and 60, and an envelope opening mylar 61 that is a elastically deformable sheet-like envelope opening member that abuts a part of the lower chuck roller 60. These components are attached to the frame 51 (refer to FIG. 10) in a unit state and moves vertically together with the sort guide section 44.

The part of the envelope opening mylar 61 is inserted into an opening of the envelope Pf held by the chuck roller pair 59 and 60 and the envelope opening mylar 61 is disposed at the position where the envelope opening mylar 61 can open the envelope Pf by inserting a part of the envelope opening mylar 61 into an opening of the envelope Pf held by the chuck roller pair 59 and 60.

The chuck roller pair 59 and 60 is disposed in an approximately vertical direction. When the mail including the envelope P or the paper is conveyed, the pair of the chuck roller pairs 59 and 60 are forced toward one another and rotate. The envelope guide pair 57 and 58 guides the envelope Pf from the vertical conveyance path 42 to the position where the paper is fed and guides the envelope to the nip portion of the chuck roller pair 59 and 60. The envelope guide pair 57 and 58 further guides the envelope Pf arrived at the chuck roller pair 59 and 60 downwardly. At this time, the envelope guide pair 57 and 58 guides the envelope Pf so that the envelope Pf moves substantially along the lower chuck roller 60.

Here, as compared with the configurations that are disclosed in Japanese Patent Nos. 3110804 and 3110806, the chuck roller pair 59 and 60 according to this embodiment adopts the unique configuration where the nip pressure can be applied or released by a nip releasing/pressurizing mechanism not shown in the drawings. The detailed description is given later.

The envelope opening mylar 61 is formed of, e.g., a thin film-like resin material, is disposed to be adjacent to the chuck roller 60, an upper end thereof is fixed, and a portion thereof slightly above the lower end is usually brought into a contact with the lower chuck roller 60 by virtue of the elastic force of the material of the envelope opening mylar 61. However, when the paper is guided into the envelope, as shown in FIG. 16, a portion near a lower end 61a is inserted into the opening Pon of the envelope Pf so that the envelope opening mylar 61 guides the paper P (refer to FIG. 10), which is fed by the pack unit 46, to the opening Pon.

As shown in FIG. 13, when the envelope Pf is conveyed to the lower side by the conveyance belt 48, the envelope chuck section 45 guides the envelope Pf between the chuck roller pair 59 and 60 by the envelope guide pair 57 and 58. Next, the envelope Pf is fed between the chuck roller 60 and the envelope opening mylar 61 by the conveyance force of the chuck roller pair 59 and 60 rotating in an arrow direction of FIG. 13, as shown in FIG. 14.

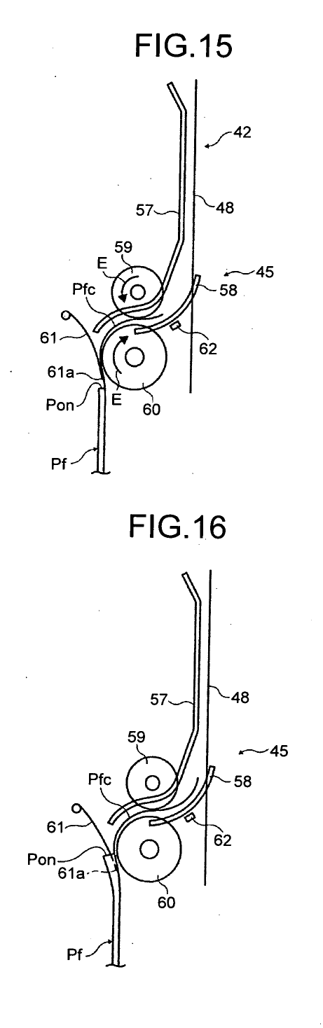

When the portion of the flap (bonding allowance) Pfc of the envelope Pf is nipped between the chuck roller pair 59 and 60 as shown in FIG. 15 and when the sensor 62 detects the passage of the end of the flap Pfc, the chuck roller pair 59 and 60 stops the rotation and feeding of the envelope Pf is stopped. At this time, feeding of the envelope Pf by a predetermined amount is made according to the longitudinal size of the envelope Pf, such that the opening Pon of the envelope Pf is positioned lower than the lower end 61a of the envelope opening mylar 61.

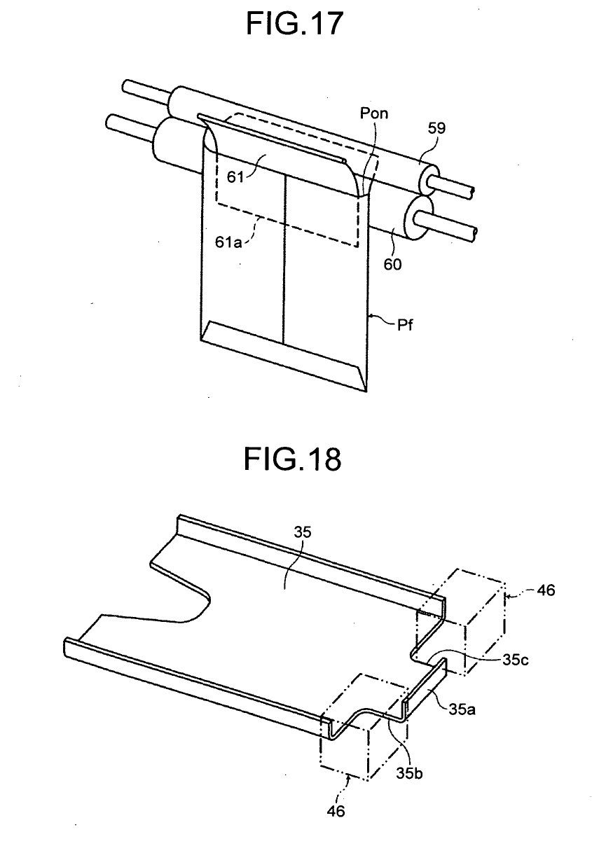

Next, the chuck roller pair 59 and 60 starts to reversely rotate in a direction of an arrow E, and the envelope Pf is switched back to go up the vertical conveyance path 42. At this time, because a portion of the envelope opening mylar 61 near the lower end 61a contacts the portion of the flap Pfc of the envelope by the self elastic force of the envelope opening mylar 61, the lower end 61a of the envelope opening mylar is inserted into the opening Pon of the envelope Pf, as shown in FIG. 16. In this state, the reverse rotation of the chuck roller pair 59 and 60 is stopped and rising of the envelope Pf is stopped. Therefore, the envelope Pf is set in an envelope opening state where the lower end 61a of the envelope opening mylar 61 is inserted into the opening Pon of the envelope Pf, as shown in FIG. 17.

Referring to FIGS. 10 and 18 to 22, the pack unit 46 will be described. As shown in FIG. 10, the pack unit 46 includes an upper pack section 63 and a lower pack section 64, and the upper roller 65 is rotatably attached to the upper pack section and the lower roller 66 is rotatably attached to the lower pack section.

A pair of upper and lower insertion guides 67 and 68 are swingably attached to the right ends, in the drawings, of the upper and lower pack sections 63 and 64, are biased by a weak spring such that the front ends thereof approach each other, and are pushed and opened when a bundle of paper P pass between the upper and lower insertion guides 67 and 68. As a result, the paper P is conveyed without receiving large resistance.

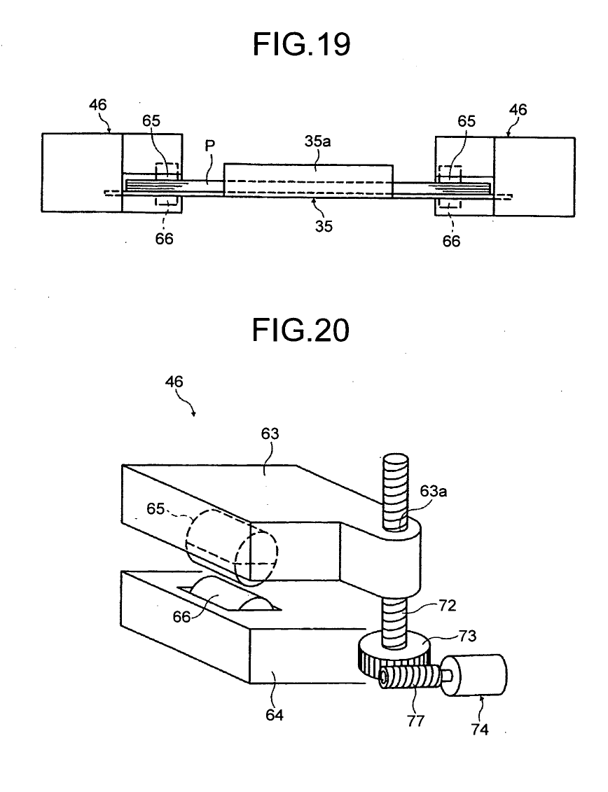

A pair of pack units 46 is provided in anteroposterior direction such that the bin 35 is located between the pack units, as shown by a virtual line in FIG. 18, and can be moved in a vertical direction in notched portions 35b and 35c, which are formed by cutting off both sides of a bin fence 35a formed an end (at right side) of the bun 35, by a mechanism described later. Thereby, as shown by a solid line in FIG. 19, the paper P on the bin 35 can be nipped between a pair of upper and lower rollers 65 and 66 at both sides.

Each pack unit 46 is attached to a pack bracket 69 shown in FIG. 10, and is configured to be swingable, together with the pack bracket 69, about a shaft 71 of the pack bracket 69 in a direction of an arrow F, until the position shown by a virtual line in FIG. 10. The pair of pack units 46 is provided to come close to or apart from each other by a mechanism using a rack and a pinion and can be moved away from or close to the notched portions 35b and 35c of the bin 35 shown in FIG. 18. The upper roller 65 and the lower roller 66 come close to or apart from each other, when the upper and lower pack sections 63 and 64 shown in FIG. 10 are closed or opened.

When the paper P is discharged to the bin 35, the pack units 46 function as a side jogger, which positions the paper on the basis of the center, by approaching each other to sandwich the paper therebetween from both sides. The pack units 46 make the upper and lower rollers 65 and 66 approach each other and nip the paper between the upper and lower rollers 65 and 66, rotate the upper and lower rollers 65 and 66 in a direction to move the paper toward the bin fence 35a, move the paper until the end of the paper bumps into the bin fence 35a, and align the end of the paper, i.e., also function as an end jogger.

FIG. 20 is a perspective view illustrating a main portion of the pack unit 46. As shown in FIG. 20, the upper roller 65 is integrated in the upper pack section 63 and exposes only the lower portion of the upper roller 65. The lower roller 66 is integrated in the lower pack section 64 and exposes only the upper portion of the lower roller 66. The upper pack section 63 has a protruding portion on a side. A female screw 63a is formed in the portion in a vertical direction. A vertical feed screw 72 is screwed into the female screw 63a.

A worm wheel 73 is fixed to a lower end of the vertical feed screw 72, and a worm 77 that is fixed to a rotation shaft of a forward/backward rotatable motor 74 is engaged with the worm wheel 73. Although not shown in FIG. 20, the vertical feed screw 72 is rotatably supported by the lower pack section 64. Therefore, when the motor 74 rotates in forward and backward directions, the upper pack section 63 moves vertically together with the upper roller 65.

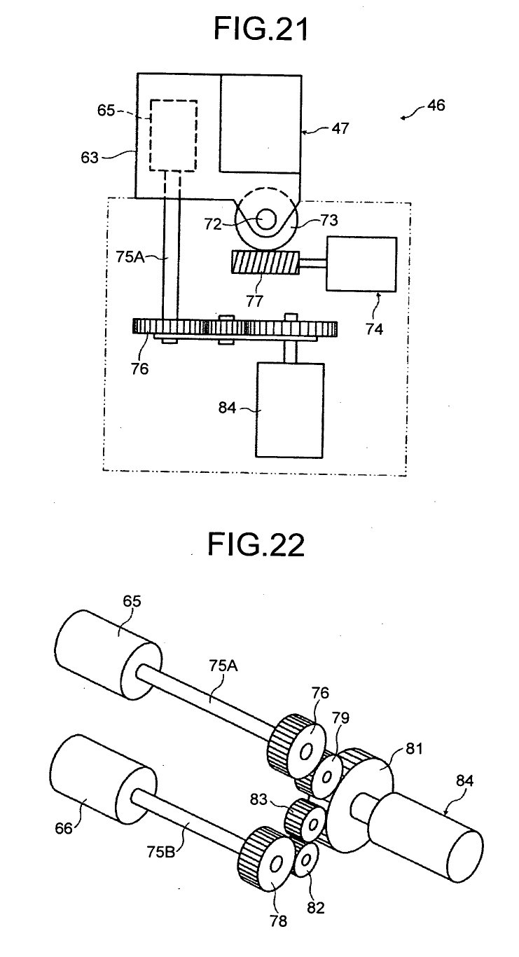

As shown in FIGS. 21 and 22, the upper roller 65 is fixed to one end of the rotation shaft 75A and the rotation shaft 75A is rotatably mounted onto the upper pack section 63. Likewise, as shown in FIG. 22, the lower roller 66 is fixed to one end of a rotation shaft 75B and the rotation shaft 75B is rotatably mounted onto the lower pack section 64 (refer to FIG. 16).

As shown in FIG. 22, a gear 76 is fixed to the other end of the rotation shaft 75A and a gear 78 is fixed to the other end of the lower rotation shaft 75B. The gear 76 is engaged with an intermediate gear 79 and the intermediate gear 79 is engaged with a driving gear 81.

Meanwhile, the gear 78 of the lower roller 66 is engaged with the intermediate gear 82 and the intermediate gear 82 is engaged with an intermediate gear 83 and the intermediate gear 83 is engaged with the driving gear 81. The driving gear 81 is fixed to an output shaft of a chuck motor 84. Since the numbers of teach are the same between the gear 76 and the gear 78, the gear 76 and the gear 78 always rotate at the same rotation number in directions reverse to each other by rotation of the chuck motor 84.

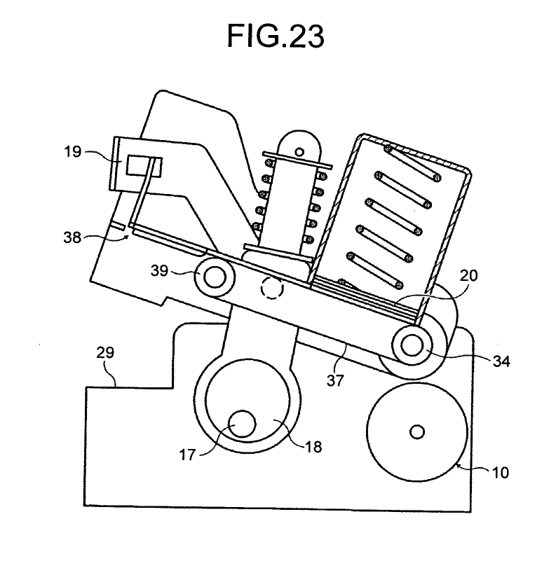

As simply shown in FIG. 21, in the pack unit 46, the stapler 47 is mounted integrally at a position near the bin fence 35a (refer to FIG. 18). The stapler 47 beats a staple driver 19 by rotation of an eccentric cam 18 rotating around a shaft 17 connected with a staple motor 10 shown in FIG. 23 via a deceleration gear not shown in the drawings, thereby beasts a staple 20, which is moved at a staple exit 38, to be inserted into the paper, etc., bends the tips of the staple by a seat 29, and finishes a staple operation.

The staple 20 is moved to the staple exit 38 by rotation of a feed belt 37. The feed belt 37 is stretched between a feed pulley 34, to which the rotation force of the staple motor 10 is transmitted through the deceleration gear, and a pulley 39.

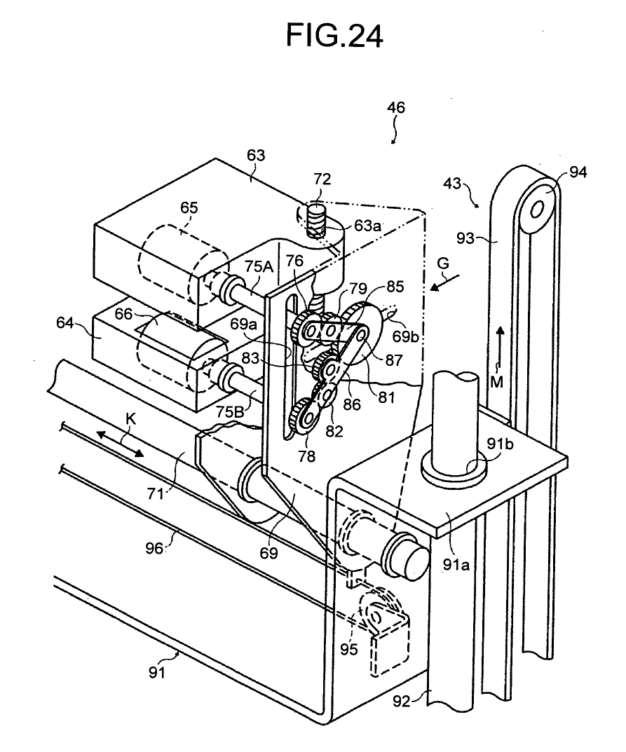

FIG. 24 is a perspective view illustrating a driving system that moves the pack unit 46. As shown in FIG. 24, rotation shafts 75A and 75B that support the upper and lower rollers 65 and 66, respectively, are movably fitted in a vertical guide groove 69a that is formed in a vertical surface of the pack bracket 69, and a group of gears that are engaged with the gear 76 fixed to one end of the rotation shaft 75A, that is, the intermediate gear 79 and the driving gear 81 are rotatably supported by an upper gear support plate 85 together with the gear 76, so that the rotation force from the driving gear 81 is smoothly transmitted to the gear 76.

The intermediate gears 82 and 83 and the driving gear 81 that are engaged with the gear 78 fixed to one end of the lower rotation shaft 75B are rotatably supported by a lower gear support plate 86 together with the gear 78, and the rotation force from the driving gear 81 is smoothly transmitted to the gear 78, similar to the afore case.

The driving gear 81 rotates in forward and backward directions by the forward/backward rotatable motor 84 shown in FIG. 22 and a shaft 87 fixedly supporting the central portion of the driving gear 81 is movably fitted into a horizontal guide groove 69b that is formed in the pack bracket 69.

Therefore, in the pack unit 46, when the motor 74 (refer to FIG. 20) that is mounted onto the pack bracket 69 is rotated, the vertical feed screw 72 rotates through the worm 77 and the worm wheel 73, and the upper pack section 63 of which the female screw 63a is engaged with the vertical feed screw 72 moves vertically.

At this time, the gear 76 and the driving gear 81 are connected by the upper gear support plate 85. Therefore, when the gear 76 is raised, the driving gear 81 moves in a direction of an arrow G in the horizontal guide groove 69b, and, accompanying this movement, the lower gear 78 that is connected to the driving gear 81 by the lower gear support plate 86 moves downward in the vertical guide groove 69a, and the rotation shaft 75B and the lower roller 66 descend.

When the motor 74 rotates in a direction to move the upper pack section 63 downwardly, the upper and lower gears 76 and 78 come close to each other and the driving gear 81 moves in a direction opposite to the direction of the arrow G, different from the above case.

The shaft 71 is fitted into the lower portion of the pack bracket 69 in a horizontal direction, and the pack unit 46 is thereby configured to move in a direction of an arrow K along the shaft 71. Likewise, another opposing pack unit 46 (refer to FIG. 19) is configured to be moved.

Both ends (in FIG. 21, only the single side is shown) of the shaft 71 are fixed to a moving frame 91. In the moving frame 91, a hole 91b that is formed in an extending portion 91a at each of both ends is fitted into a guide rod 92 that is vertically fixed to the fixed portion of the device body of the SSP device 3, and one side edge of the extending portion 91a is fixed to a part of a driving belt 93 that is stretched between upper and lower pulleys 94 (only the upper pulley is shown in FIG. 24) that is rotatably mounted onto the fixed portion of the device body of the SSP device 3 and that constitutes the elevating device 43.

Therefore, the pack unit 46 moves vertically integrally with the moving frame 91 by rotating the driving belt 93 in forward and backward directions, the sort guide section 44 and the envelope chuck section 45 shown in FIG. 10 are attached to the moving frame 91 through the frame 51 (or may be directly attached), and thus all of these are integrally moved in a vertical direction.

In the pack unit 46, the pack bracket 69 can rotate, i.e., swing by a predetermined angle in a direction of an arrow F of FIG. 10 about the shaft 71, up to a position shown by a virtual line.

A mechanism that swings the pack bracket 69 can be easily configured by those who are skilled in the art, for example, as a mechanism in which one end of a link rod connected to a rotation plate fixed to a rotation shaft of a motor and linearly moving is connected to the pack bracket 69 by a ball joint, moves the link rod, and the pack bracket 69 is rotated about the shaft 71 by moving the link rod, or a mechanism in which a spline is formed in the shaft 71 across all of a range where the pack bracket 69 moves, a sparring gear is fixed to an end of the shaft, and the pack bracket 69 is rotated by transmitting driving force to the gear.

The movement of the pack unit 46 in a direction of an arrow K in FIG. 24 is made by a driving wire 96 that is stretched between pulleys 95 (in FIG. 24, only one of the pulleys is shown) rotatably attached to both ends in the moving frame 91, a part of the wire 96 is fixed to the lower end of the pack bracket 69, and the wire 96 is rotated in forward and backward directions by a jogger motor not shown in the drawings.

A configuration where a predetermined pressure is applied to the paper according to the shapes and the materials of the upper and lower rollers 65 and 66 and the outer diameters of the upper and lower rollers 65 and 66, and the paper is conveyed to be positioned at the “feed mode position”, is the same as the technical content shown in FIGS. 21 to 24 of Japanese Patent Nos. 3110804 and 3110806 and described in the paragraphs [0067] to [0069] of Japanese Patent No. 3110804. Therefore, the detailed description is omitted.

Meanwhile, the positions of the upper roller 65 and the lower roller 66 include the “jog mode position” in addition to the above-described “feed mode position”. Each position is determined by the positions of the upper pack section 63 and the lower pack section 64 of FIG. 20 and is determined by the rotation amount of the motor 74.

The “jog mode position” and the “feed mode position” change depending on the number of paper on the bin 35. The optimal position is always obtained by reading out data indicating a relationship between the corresponding rotation amounts of the motor 74 and the various numbers of paper stored in a ROM 132 (refer to FIG. 37) of the control device 120.

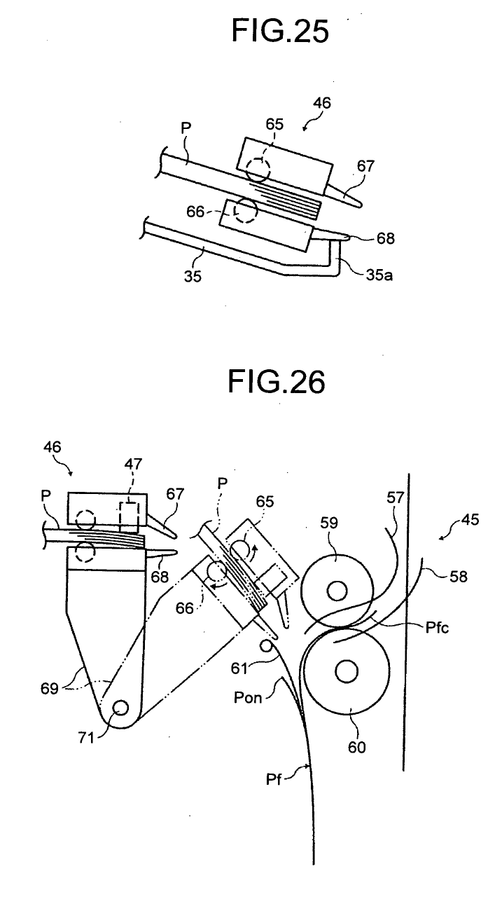

Referring to FIGS. 25 to 27, an enclosing mechanism that includes an enclosing unit to enclose a mailable content in the envelope will be described. Hereinafter, “paper” is described as a representative of the mailable content.

When a pack mode (also called envelope enclosing mode) where the paper is included or enclosed in the envelope is selected, the upper and lower rollers 65 and 66 of respective pack units 46 are moved toward each other to nip the paper P (paper bundle when the paper is stapled and bound) therebetween by rotating the motor 74 (refer to FIG. 20) when the pack units 46 are located at a position shown in FIG. 19.

Next, the driving belt 93 shown in FIG. 24 is rotated in a direction of an arrow M to lift the pack unit 46. This lifting is stopped when the bottom surface of the nipped paper P is raised beyond the upper end of the bin fence 35a of the bin 35 as shown in FIG. 25.

Then, as shown in FIG. 26, the pack unit 46 is swung about the shaft 71 to move the insertion guides 67 and 68 at a forward side to the opening Pon of the envelope Pf in a state where the opening Pon is opened in the envelope chuck section 45, as described in FIGS. 16 and 17. The insertion guides 67 and 68 are moved to an upper portion of the envelope opening mylar 61 or in an inside of the opening Pon of the envelope.

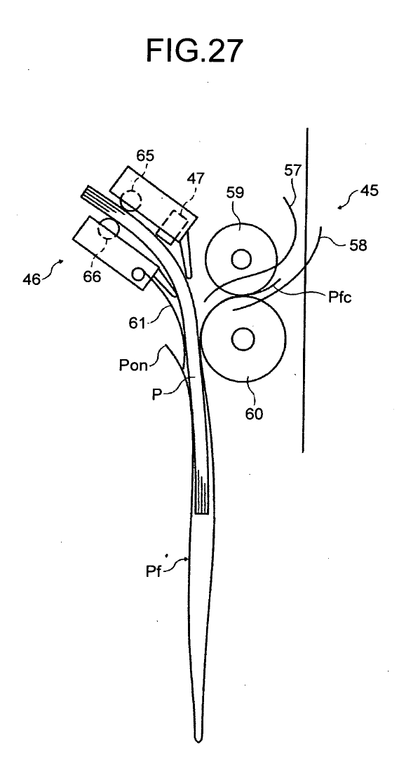

In this state, the upper and lower rollers 65 and 66 of the pack unit 46 are rotated in a direction (feed direction) of an arrow in FIG. 26, and the paper P nipped therebetween is inserted into the envelope Pf, as shown in FIG. 27.

In this way, in this embodiment, the envelope Pf is guided by the envelope guides 57 and 58 to the position where the paper P is fed, and the guided paper is held by the pair of chuck rollers 59 and 60. Subsequently, the lower end 61a of the envelope opening mylar 61 is inserted into the opening Pon of the envelope Pf and the opening Pon is opened, and then the paper P that is fed by the pack unit 46 is inserted into the opening Pon of the envelope Pf.

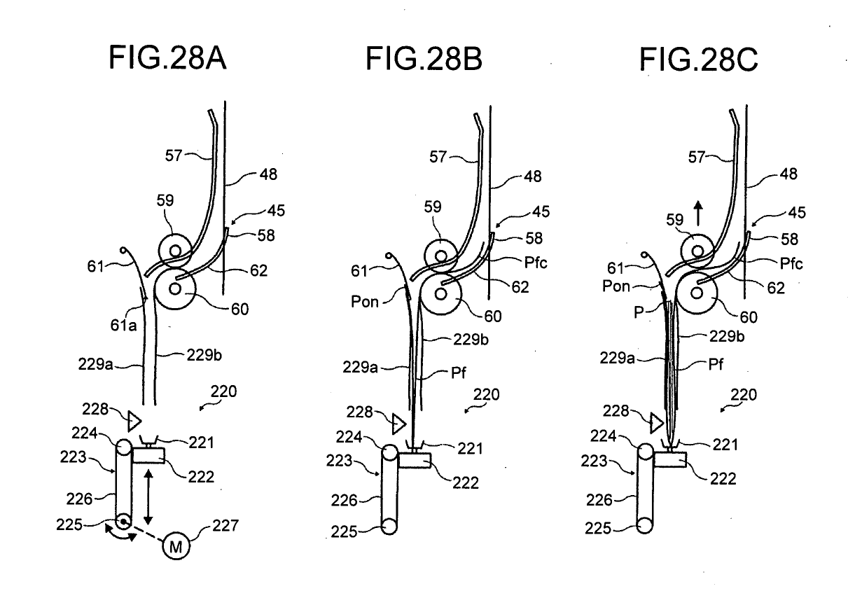

Referring to FIGS. 28A to 28C to 30, a weight measuring device that measures the weight (mass) of the mail will be described. FIGS. 28A to 28C show a configuration of a weight measuring device 220 to measure the weight (mass) of the envelope and an operation transition when the weight is measured according to this embodiment. In FIGS. 28A to 28C, the pack unit 46 shown in FIG. 27 is omitted for the sake of conciseness of the drawing.

The weight measuring device 220 has the configuration that can be also called a weight measuring mechanism. The weight measuring device 220 mainly includes an envelope fence 221 on which an envelope in which a paper is enclosed (hereinafter referred to as a “paper enclosed envelope”) is carried, a load cell 222 that functions as a weight measuring unit or a weight detecting unit attached to the lower portion of the envelope fence 221, a vertical moving mechanism 223 that vertically moves the load cell 222 together with the envelope fence 221 according to the size of a mail (envelope), a nip pressure releasing/applying mechanism that releases or applies the nip pressure of the chuck roller pair 59 and 60 (broadly-defined configuration).

The weight measuring device 220 may have the narrowly-defined configuration where an envelope arrival sensor 228 and a pair of side plates 229a and 229b described later are added to the broadly-defined configuration.

Here, a weight recognizing unit that recognizes the weight of the mail includes a weight setting unit to manually set the weight of the mail, in addition to the weight measuring unit composed of the load cell 222. In a specific example of the weight setting unit, the size of the mail is manually set 1 using the ten key 105, the enter key 107, the display section 104, etc. that are disposed in the operation panel 100 shown in FIG. 36.

The load cell 222 is a sensor that converts the force (mass or torque) into an electric signal and outputs the electric signal. As the load cell 222, plural distortion gauges may be bonded or a semiconductor may be configured as a converting element. As the load cell 222, a load cell that has sensitivity and a measurement range allowing the total weight of the “paper enclosed envelope” to be measured is selected in this embodiment.

The vertical moving mechanism 223 mainly includes a pair of a driven pulley 224 and a driving pulley 225 that are rotatably supported to the frame 51 (refer to FIG. 10, etc.), an endless belt 226 that is stretched between the pulleys 224 and 225 and is adhered to a non-measurement portion of the load cell 222, and a driving motor 227 (refer to FIG. 28A) that is connected to the driving pulley 225 through a driving transmitting unit such as a gear not shown in the drawings. In FIGS. 28B and 28C, the driving motor 227 is not shown for the sake of conciseness of the drawings.

The driving motor 227 is adhered to the frame 51 (refer to FIG. 10). As the driving motor 227, a stepping motor that is driven by a pulse input and is suitable for control to vertically move the load cell 222 together with the envelope fence 221 by a predetermined movement amount according to the size of the mail (envelope in this embodiment) through the driving pulley 225 and the belt 226 is preferably used. In order to accurately perform this control, it is preferable that the initial position in which the envelope fence 221 is held in a waiting state described later is previously determined according to the size (longitudinal length L″ of FIG. 9) of the envelope as a reference, and a home position sensor that detects the initial position is disposed.

The chuck roller pair 59 and 60 is configured to allow the nip pressure to be released by the nip pressure releasing/applying mechanism not shown in the drawings. In a state where the nip pressure of the chuck roller pair 59 and 60 is released by the nip pressure releasing/applying mechanism (in this case, the nip pressure is released in a state where the chuck roller 59 is apart from the chuck roller 60), the paper enclosed envelope is carried on the envelope fence 221 mounted onto the load cell 222. As a result, measurement can be performed in a state where frictional resistance externally applied to the paper enclosed envelope is maximally excluded, and thus only the weight (mass) of the paper enclosed envelope is measured.

As the nip pressure releasing/applying mechanism not shown in the drawings, a “pressure applying/releasing mechanism of a first sheet feeder” that is shown in FIG. 6 of Japanese Unexamined Patent Publication No. 2009-58763 suggested by the inventors of the present application is preferable.

Under and between the lower chuck roller 60 and the lower end 61a of the envelope opening mylar 61, a pair of side plates 229a and 229b that function as a mail guiding member to surely guide the lower end of the envelope opposite to the flap Pfc of the envelope Pf onto the envelope fence 221 are disposed. The side plate pair 229a and 229b is adhered to the frame 51 (refer to FIG. 10, etc.), extend in a vertical direction and a depth direction of a plane of paper (width direction of the envelope Pf or the paper), and are disposed to be approximately parallel to each other. The side plate pair 229a and 229b are kept in a communication state where upper and lower ends thereof are opened, and are configured to guide the envelope Pf so that the envelope Pf is dropped by the self weight and the lower end of the envelope Pf is carried onto the envelope fence 221. The side plate pair 229a and 229b are preferably formed of a material that does not apply the frictional resistance to the mail (envelope Pf) to enable accurate weight measurement, that is, for example, a thin plate that has the small frictional coefficient with respect to the mail (envelope Pf) and easily discharges the generated static electricity.

The envelope arrival sensor 228 detects the arrival of the mail (envelope), which has passed the side plate pair 229a and 229b, to the envelope fence 221 to trigger the start of the weight measurement by the load cell 222. For example, a reflective photo sensor or a transmissive photo sensor with a light shielding piece (filler) is used as the envelope arrival sensor 228.

The operation of the weight measuring device 220 will be sequentially described.

(1) First, the vertical moving mechanism 223 is operated so that the envelope fence 221 and the load cell 222 that is the measuring mechanism is moved from the previously set initial position to a set position according to the size of the envelope and is waited. The set position is set such that the distance between the top surface (envelope contacting surface) of the envelope fence 221 and the center of the nip portion of the chuck roller pair 59 and 60 along the conveyance path is equal to or more than the longitudinal length (longitudinal length L″ in FIG. 9) of the used envelope Pf (refer to FIG. 28A), to measure only the weight of the paper enclosed envelope Pf.

(2) By the enclosing mechanism, the fed envelope Pf is opened and the paper is inserted and enclosed in the envelope Pf from the opening Pon. At this time, the envelope arrival sensor 228 on-detects the lower portion of the envelope Pf (refer to FIGS. 28B and 28C).

(3) After the enclosing of the paper into the envelope Pf (refer to FIG. 28C), the nip pressure of the chuck roller pair 59 and 60 is released by the nip pressure releasing/applying mechanism not shown so that almost all of the weight of the envelope Pf is applied to the load cell 222. Then, weight measurement described next is executed on the basis of an on signal output from the envelope arrival sensor 228.

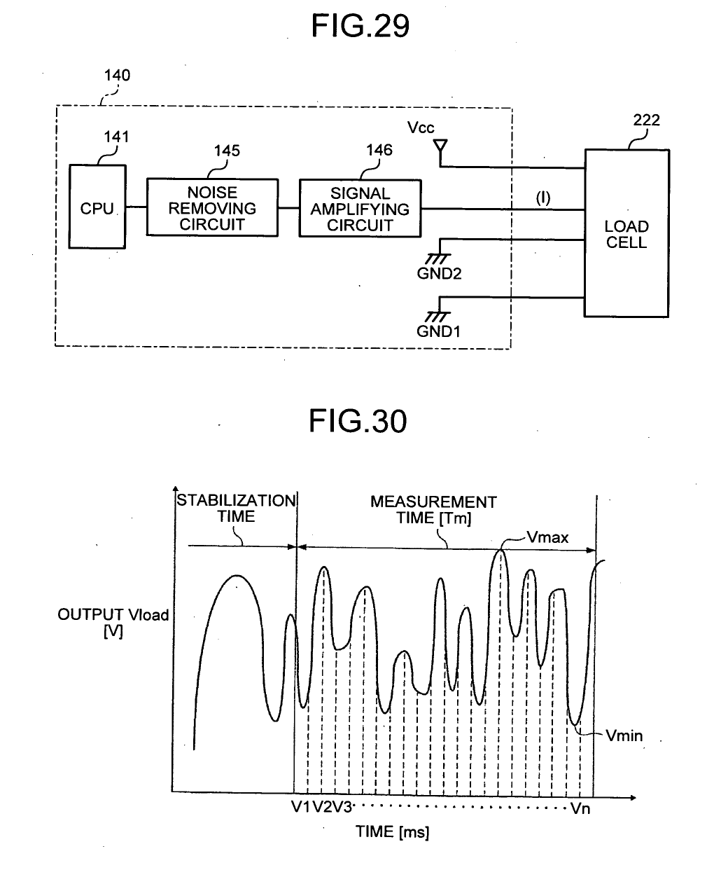

Referring to FIGS. 29 and 30, a weight measuring method that measures the weight of the envelope Pf using the load cell 222 will be described. FIG. 29 is a block diagram of the weight measuring section using the load cell 222.

As shown in FIGS. 29 and 30, the load cell 222 and an SSP control board 140 (this means a control device of the SSP device 3, which is described later with reference to FIG. 37) are connected by four electric lines of a power supply voltage Vcc: 12 V, GND1, GND2, and an output signal (1). The GND is divided into two systems of the GND1 of a 12 V power supply system and the GND2 of a signal system to decrease the noise. An output VLoad (V) of the load cell 222, after potential thereof is amplified by a signal amplifying circuit 146 in the SSP control board 140, passes a noise removing circuit 145, and is read by a CPU 141 at an analog port (not shown in the drawings) so that the weight can be measured.

FIG. 30 shows a relationship of output voltage VLoad data (vertical axis) after subjected to an AD (analog/digital) conversion in the CPU 141 and a time (horizontal axis). Before the measurement of the weight starts, a time until the output VLoad is stabilized, that is, a stabilization time is generally set in consideration of existence of a time corresponding to an unstable output voltage VLoad as a characteristic of the load cell 222. After the stabilization time passes, the CPU 141 reads weight data of the envelope that is close to a true value. The read value is measured by a fixed number in Tm time, where as the time Tm denotes a measurement time. In order to minimize the measurement error, an average of the (n−2) output voltage data other than the maximum value Vmax and the minimum value Vmin among the measured data is used. The weight (corresponding voltage) VL that is measured in the above-described way can be calculated by the following equation (5).

VL={(V1+V2+ . . . Vn)−(Vmax+Vmin)}/(n−2) (5)

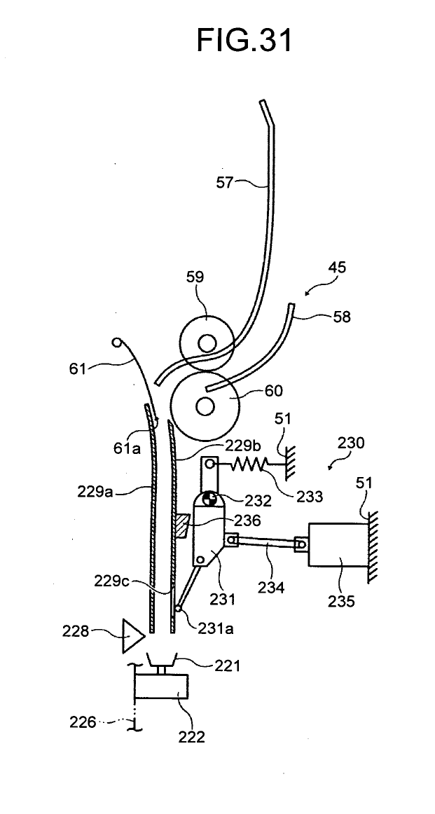

Referring to FIGS. 31 to 35, a thickness measuring device that measures the thickness of the mail will be described. FIG. 31 shows the configuration of a thickness measuring device 230 that measures the thickness of the envelope according to this embodiment. In FIG. 31, the pack unit 46 shown in FIG. 27, etc. and the vertical moving mechanism 223 shown in FIGS. 28A to 28C are not shown for the sake of conciseness of the drawing.

As shown in FIG. 31, the thickness measuring device 230 has the configuration that can also be called a thickness measuring mechanism and is configured to measure the thickness of the mail (paper enclosed mail or postcard, this is the same in the following description). That is, the thickness measuring device 230 includes an electronic micrometer 231 that functions as a thickness measuring unit or a thickness measurer that measures the thickness of the paper enclosed envelope Pf, a pull-type solenoid 235 that functions as a driving unit to change the position of the electronic micrometer 231 to the evacuation position corresponding to the non-thickness measurement position described later, a link 234 that connects the solenoid 235 and a body of the electronic micrometer 231, a spring 233 that functions as a biasing unit to bias the electronic micrometer 231 in a direction to always swing electronic micrometer 231 clockwise about a support shaft 232, the vertical moving mechanism 223 (not shown in FIG. 31) and a nip pressure releasing/applying mechanism that are the same as those disposed in the weight measuring device 220 in FIGS. 28A to 28C (broadly-defined configuration).

The thickness measuring device 230 may have the narrowly-defined configuration where the envelope fence 221, the envelope arrival sensor 228, and the pair of side plates 229a and 229b that are the same as those disposed in the weight measuring device 220 are added to the broadly-defined configuration.

The electronic micrometer 231 includes a measurement element 231a that is capable of microscopic displacement to contact a thickness measurement surface (external surface at a portion having the maximum thickness of the envelope Pf in this embodiment). The electronic micrometer 231 is known and used to convert the microscopic displacement of a thickness measurement portion into the electric amount (pulse number) and measure the microscopic displacement or the thickness.

Here, the electronic micrometer 231 executes a function as a thickness detecting unit to detect the thickness of the mail, in addition to a function as the thickness measuring unit. The thickness recognizing unit that recognizes the thickness of the mail includes a thickness setting unit in which the thickness of the mail is manually set, in addition to the electronic micrometer 231 functioning as the thickness measuring unit. As a specific example of the thickness setting unit, there can be exemplified a configuration in which the thickness of the mail is manually set using the ten key 105, the enter key 107, the display section 104, etc. that are disposed in the operation panel 100 shown in FIG. 36.

The support shaft 232 extends to the inner side of a plane of paper in the drawings and both ends thereof are supported by the frame 51 rotatably within a predetermined angle range. One end of the spring 233 is locked to an upper end of the electronic micrometer 231 and the other end is locked to the frame 51. The spring 233 is composed of a tension spring to which a predetermined spring constant is set, biases the electronic micrometer 231 in a direction to always swing the electronic micrometer 231 clockwise to cause the measurement element 231a to occupy the default position described later and the measurement position in which the measurement element 231a contacts the exterior surface of the envelope Pf in which the paper is enclosed.

On the right side plate 229b in FIG. 31, an opening 229c is formed so that, when the measurement element is swung clockwise about the support shaft 232 to cause the electronic micrometer 231 to occupy the measurement position and the default position, the measurement element 231a is inserted into the opening 229c.

The electronic micrometer 231 is held while being biased by the spring 233 with the support shaft 232 as the swinging center. On an external wall surface of the side plate 229b that faces the electronic micrometer 231, a stopper member 236 (hatched in the drawings) that is used to regulate the displacement of the electronic micrometer 231 to prevent the excessive displacement of the electronic micrometer 231 is fixed. The link 234 is connected to the electronic micrometer 231 and an output shaft (plunger) of the solenoid 235.

When only the thickness is measured, the load cell 222 may be removed from the thickness measuring device 230. However, in this embodiment, since both the weight and the thickness of the envelope Pf are measured, the configuration that is shown in FIG. 31 is adopted.

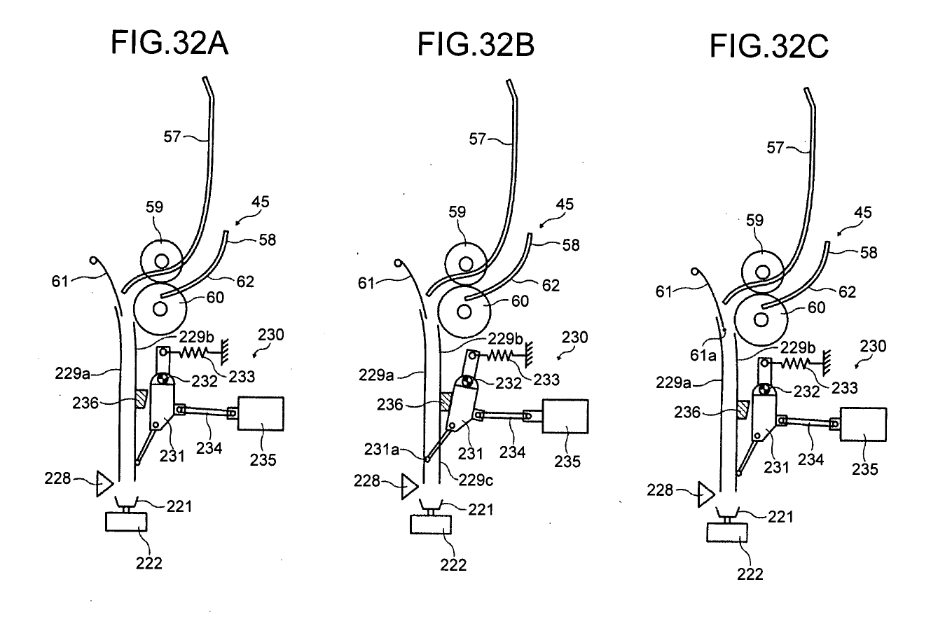

The shapes, the spring constant, etc. of the components of the thickness measuring device 230 are set, such that the measurement element 231a of the electronic micrometer 231 contacts an inner wall surface of the side plate pair 229a by the biasing force of the spring 233 (refer to FIG. 32B) when power supply to the solenoid is in the off state (hereinafter, also referred to as “solenoid 235 is in the off state”), while the measurement element 231a of the electronic micrometer 231 is in an evacuation state where the electronic micrometer 231 occupies the evacuation position (refer to FIG. 32A) when power supply to the solenoid is in an on state (hereinafter, also referred to as “solenoid 235 is in the on state”).

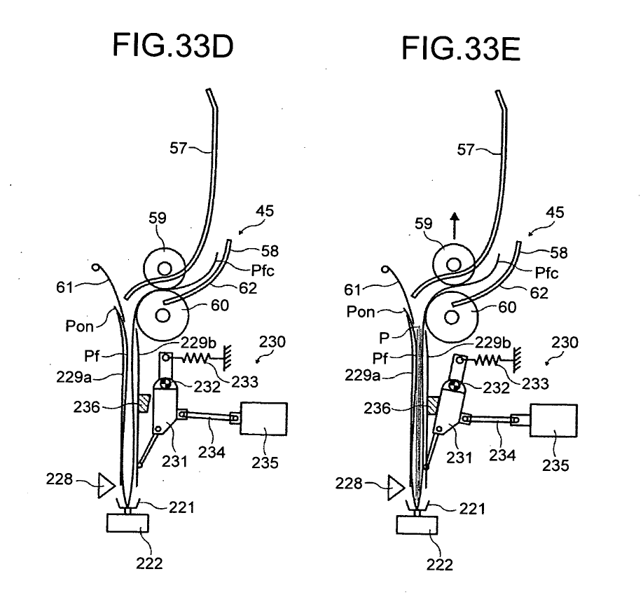

Referring to FIGS. 32A to 32C, 33D and 33E, the transition of the thickness measuring operation of the thickness measuring device 230 will be sequentially described.

(1) First, similar to the initial operation of the weight measuring device 220 shown in FIG. 28A, the vertical moving mechanism 223 is operated so that the envelope fence 221 and the load cell 222 move from the initial position to the set position according to the size of the envelope and is waited (refer to FIG. 32A).

(2) Next, the solenoid 235 is switched from the on state to the off state (from FIG. 32A to FIG. 32B), and a numerical value output from the electronic micrometer 231 is acquired when the measurement element 231a of the electronic micrometer 231 contacts the inner surface wall of the side plate 229a as shown in FIG. 32B, that is, default value of when the thickness is measured is acquired. Thereby, the default thickness of the electronic micrometer 231 in the state shown in FIG. 32B is measured. The measured value is defined as Ddef.

(3) The solenoid is switched from the off state to the on state (from FIG. 32B to FIG. 32C) to cause the envelope Pf to be ready for reception.

(4) In a state where the solenoid 235 is kept in the on state, after the envelope Pf is loaded on the envelope fence 221 mounted onto the load cell 222 by the enclosing mechanism described above (at this time, the envelope arrival sensor 228 on-detects the lower portion of the envelope Pf), the envelope Pf is opened and the paper is inserted and enclosed in the envelope PF from the opening Pon (refer to FIGS. 33D and 33E).

(5) After the paper is enclosed in the envelope Pf (refer to FIG. 33E), similar to the operation of the weight measuring device 220 shown in FIG. 28C, the nip pressure of the chuck roller pair 59 and 60 is released by the nip pressure releasing/applying mechanism not shown in the drawings so that almost the entire weight of the envelope Pf is applied to the load cell 222, and the paper in the envelope Pf is dropped onto a bottom portion of the envelope Pf to become a stable enclosed state. Then, before or after the weight measurement performed based on the on signal from the envelope arrival sensor 228, the solenoid is switched from the on state to the off state, and the thickness is measured by the electronic micrometer 231 in a state shown in FIG. 33E. At this time, the measurement element 231a of the electronic micrometer 231 that is biased by the predetermined biasing force of the spring 233 is positioned to be able to enter in the opening 229c (refer to FIG. 31) of the side plate 229b not shown in FIGS. 33E, and thus contacts the external right side surface at the lower portion of the envelope Pf at which the thickness is increased because the paper is enclosed, to measure the thickness of the envelope Pf at the corresponding portion. A measured value at this time is defined as Da.

(6) The value of the thickness of the paper enclosed envelope Pf is calculated as Da−Ddef.

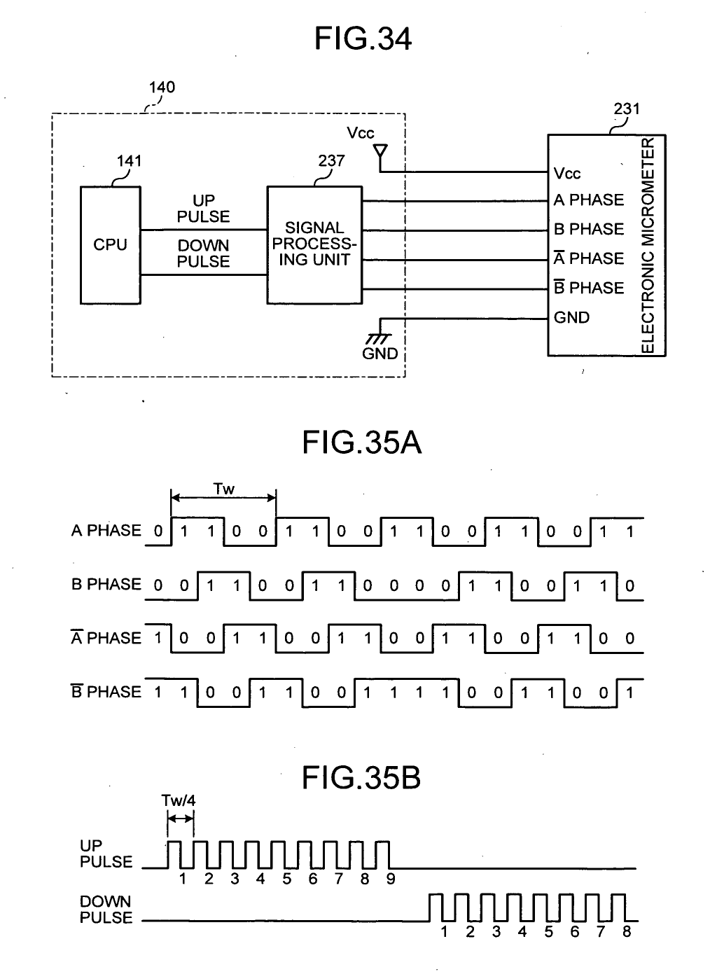

Referring to FIGS. 34 and 35, a thickness measuring method that measures the thickness of the envelope Pf using the electronic micrometer 231 will be described. FIG. 34 is a block diagram of a thickness measuring section of the envelope Pf using the electronic micrometer 231.

As shown in FIGS. 34 and 35, the electronic micrometer 231 and the SSP control board 140 are connected by a total of 6 electric lines of power supply voltage Vcc: 5 V, GND, A phase, B phase, A (upper bar) phase, and B (upper bar) phase.

An output signal from the electronic micrometer 231 is waveform shaped in an up pulse (hereinafter, referred to as “UP PULSE”) and a down pulse (hereinafter, referred to as “DOWN PULSE”) by a signal processing unit 237 in the SSP control board 140 and is input to the CPU 141.

FIG. 35A shows an output signal from the electronic micrometer 231. The output signal from the electronic micrometer 231 is output in each phase of the A phase, the B phase, the A (upper bar) phase, and the B (upper bar) phase. By viewing a state of the four phases, the movement distance of the electronic micrometer 231 can be known. FIG. 35A shows a waveform when the electronic micrometer 231 moves to a certain position in a + (plus) direction and then returns in a − (minus) direction. The movement distance is defined as a step amount per phase and is a value unique to the electronic micrometer 231. In this case, the step amount per one pulse (hereinafter, described as “PULSE” or “pls”) is defined as 0.02 (mm/pls).

A result of waveform shaping performed to the output signal of FIG. 35A by the signal processing unit 237 in the SSP control board 140 is shown in FIG. 35B. In the shaped waveform, it can be seen that the movement amount per one PULSE becomes ¼ and the resolution becomes four times. In this case, it can be seen that movement is performed in a + direction by 9 pulses (0.02/4×9)=0.045 and then in a − direction by an amount corresponding to 8 pulses (0.02/4×8)=0.040 mm). The two signal lines (UP PULSE and DOWN PULSE) are input to the CPU 141, and the thickness is calculated using a timer function (internal timer) of the CPU 141. When an UP PULSE timer count of the CPU 141 is defined as Tup, a DOWN PULSE timer count is defined as Tdwn, and the timer count starts at a rising edge, the thickness D (mm) is calculated as follows.

D (mm)=(Tup−Tdwn)×0.02/4=(9−8)×0.005=0.005 (mm)

Similar to the case of the output of the load cell, the output thickness D changes depending on a measurement time, as shown in FIG. 30. Therefore, similar to the load cell, stabilized data can be obtained by averaging a certain number of pieces of data to calculate the thickness D.

The thickness measurement of the envelope using the electronic micrometer 231 is not limited to the above described method and the thickness may be calculated as follows. That is, although not shown in the drawings, the thickness of the envelope may be measured at plural positions using the plural electronic micrometers 231 to accurately measure the thickness of the envelope. The electronic micrometer 231 may be configured to move relative to the envelope in a horizontal direction and a vertical direction, and the thickness of the whole surface of the envelope may be measured.

Next, the operation panel 100 will be described with reference to FIG. 36. FIG. 36 is a plan view illustrating a main portion of the operation panel 100 where various operation keys used to select various modes and set various copy conditions are provided.

In the operation panel 100, a package key 101 that is pressed when a “pack mode (envelope enclosing mode)” to automatically enclose the paper in the envelope is selected, a sort key 102 that is pressed when a “sort mode” to sort the copied paper and discharge the paper to the bin is selected, and a staple key 103 that is pressed when a “staple mode” to bind the paper on the bin is selected are provided on an upper right side in FIG. 36. Further, in the operation panel 100, a display section 104 that is disposed on an upper left side in FIG. 36 and displays a size of an envelope in which paper can be enclosed, information indicating that there is no envelope in which the paper can be enclosed, etc. is provided.

As described above, first, the display section 104 functions as the mail size notifying unit or the mail size display unit. Second, the display section 104 functions as a first notifying unit or a first display unit that notifies or displays the postage calculated by the control device 120. Third, the display section 104 functions as a second notifying unit or a second display unit that notifies the weight data recognized by the weight measuring device 220 functioning as the weight recognizing unit. Fourth, the display section 104 functions as a third notifying unit or a third display unit that notifies that the postage cannot be calculated by the control device 120, when the postage cannot be calculated.

Further, 10 ten keys (function as a sheet number setting unit to set the paper number) that are used when the copy number of paper is set/instructed, the number of paper enclosed in the envelope is set, an original circulating mode is selected are disposed on the lower side of the package key 101, etc. are provided under the package key 101. A stop/clear key 106 is provided in the lowermost step of the ten keys. An enter key 107 is provided on the right side of the stop/clear key 106. A start key 108 that is pressed when the copy starts is provided above the enter key 107.

On the lower side of the display section 104, paper/envelope selecting keys 109a to 109e and a paper/envelope display portion 110 at which illustrations drawing individual trays to correspond to the five selecting keys are displayed and two left and right lamps are disposed below each illustration are provided. When the envelope is selected, the right lamp is turned on with a green color and an envelope size is displayed below the lamp.

When the paper (copying paper) is selected, the left lamp is turned on with an orange color and a paper size is displayed below the lamp. A key that is provided below the paper/envelope selecting key 109e is an envelope selecting mode switching key 111. The envelope selecting mode switching key 111 is pressed when a mode to automatically select the envelope having the optimal size to enclose the paper on the bin in the envelope or a mode to allow the operator to freely select the envelope size is selected.

In this embodiment, similar to Japanese Patent Nos. 3110804 and 3110806, when it is determined that there are plural paper having the size in which the paper can be enclosed by the collation of the size of the envelope capable of enclosing the paper fed from the feed section 11 and the envelope set to the device body 1A, a “first mode” or an “automatic envelope selecting mode” to automatically select the envelope having the minimum size, a “second mode” or an “envelope operator selection mode” to display all of the envelops having the size allowing the paper to be enclosed on the display section 104, and an “envelope operator support mode” to inform the envelope having the size allowing the paper to be enclosed by flickering the illustration in the paper/envelope display portion 110 can be selected by pressing the envelope selection mode switching key 111 (refer to FIG. 36) functioning as the mode selecting unit.

The operation unit is not limited to the operation panel 100 of FIG. 36 and may configured to allow the operation instructions to be sequentially and hierarchically set in a touch panel system, etc.

Next, the entire control configuration of the image forming system according to this embodiment will be described with reference to FIG. 37. FIG. 37 is a block diagram illustrating the control device 120 to wholly control the image forming system of the copy machine 1 and the SSP device 3 in this embodiment, and illustrating the association configuration thereof. The control device 120 includes a main control board 130 that controls an image forming system in the copy machine 1 and an SSP control board 140 that performs operation control of the sort/staple/package, etc.

The main control board 130 includes a central processing unit (CPU) 131 that has various determining and processing functions, a read only memory (ROM) 132 that stores processing programs including a program needed to control various driving systems in the copy machine 1 (refer to FIGS. 1 and 2) and fixed data, a random access memory (RAM) 133 that is a data memory to store processing data, and an input/output circuit (I/O).

The CPU 131 of the main control board 130 receives an output sensor signal corresponding to a paper size or an envelope size from each size detecting sensor 32 provided in each of feed cassettes 15A to 15D (refer to FIG. 1) of the feed section 11 and the size measuring device 200 provided in the tray 24, receives sensor signals from various sensors such as a synchronization detecting sensor and a paper end sensor, determines timing to turn on/off various loads such as various discharge devices, a developing motor, a high-voltage power supply, a polygon motor, the semiconductor laser of the writing section 6 in FIG. 2, the fixing device, and a motor to drive the photosensitive drum 7, and executes an entire sequence operation.

The main control board 130 is connected to the various keys provided in the operation panel 100 (refer to FIG. 36), a scanner control board 122 that is the control circuit of the image scanning section 5 of FIG. 2, and an RDH control board 123 that is the control circuit of the RDH of FIG. 2, and is connected to a personal computer 125 through an external interface 124. Each control board The main control board 130 is configured to enable bidirectional communication with, and receive and send a command from and to these control board, etc. The scanner control board 122 and the external interface 124 also receive an output of the image data.

Similar to the main control board 130, the SSP control board 140 includes a central processing unit (CPU) 141 that has various determining and processing functions, a read only memory (ROM) 142 that stores processing programs including a program needed to control various driving systems in the SSP device 3 (refer to FIG. 2) and fixed data, a random access memory 143 that is a data memory to store processing data, and an input/output circuit (I/O).

The SSP control board 140 is connected to the main control board 130, serial communication is enabled between the SSP control board 140 and the main control board 130, and the SSP control board 140 is operated according to a command transmitted from the main control board 130. The CPU 141 of the SSP control board 140 receives various detection signals from various sensors, such as the envelope arrival sensor 228 (refer to FIGS. 28A to 28C and 31), each home position sensor (not shown in the drawings) to detect each home position of the SSP unit 40 in each of upward, downward, left and right directions, a sensor (not shown in the drawings) to detect a mounting state of the storage carrier 4 (refer to FIG. 2), a sensor (not shown in the drawings) to detect the envelope failed to be discharged to the storage carrier 4, etc., and the envelope detecting sensor 62 (refer to FIGS. 10 and 16).

The CPU 141 of the SSP control board 140 receives a weight measurement signal from the load cell 222 of the weight measuring device 220 shown in FIGS. 28A to 28C and 29 and a thickness measurement signal from the thickness measuring device 230 shown in FIGS. 31 to 34.

The CPU 141 of the SSP control board 140 outputs driving signals to a motor driver to drive a motor 151 rotating the pulley 49 (refer to FIG. 10) on which the conveyance belt 48 constituting the vertical conveyance path 42 is stretched, a motor driver to rotate a chuck roller driving motor 153 of the envelope chuck section 45, and a motor driver to drive a motor 155 to cause the pair of pack units 46 to approach each other or be apart from each other, according to the size of the paper on the bin 35.

The CPU 141 of the SSP control board 140 outputs driving signals to a motor driver to rotate a motor 157 to lift and descend the SSP unit 40 (refer to FIG. 10), a motor driver to drive the motor 74 (refer to FIG. 20) to descend the upper roller 65 and nip the paper on the bin 35 between the upper roller 65 and the lower roller 66, a motor driver to drive the chuck motor 84 (refer to FIG. 22) to rotate the upper and lower rollers 65 and 66, a motor driver to drive the driving motor 227 of the vertical moving mechanism 223 shown in FIGS. 28A to 28C, etc., a driver to drive the solenoid 55 to swing the sort guides 53 and 54, and a driver to drive the solenoid 235 of the thickness measuring device 230.

The CPU 141 of the SSP control board 140 (hereinafter simply referred to as “SSP control board 140” to simplify the description) outputs driving signals to a motor driver to drive a motor 159 to move the positions of the vertical bins provided in the storage carrier 4 to allow the paper enclosed envelope to be discharged to the desired vertical bin, and a motor driver to drive the staple motor 10 to operate the stapler 47 (refer to FIG. 37).

This embodiment has the above configuration and the control configuration of FIG. 37 so that the operation that is disclosed in the flowchart of FIGS. 30 and 31 of Japanese Patent No. 3110804 and the operation that is described in the paragraphs [0082] and [0086] to [0113] can be executed. In addition, the operation that is disclosed in the flowchart of FIGS. 30 to 34 of Japanese Patent No. 3110806 and the operation that is described in the paragraphs [0096] to [0121] can be executed.

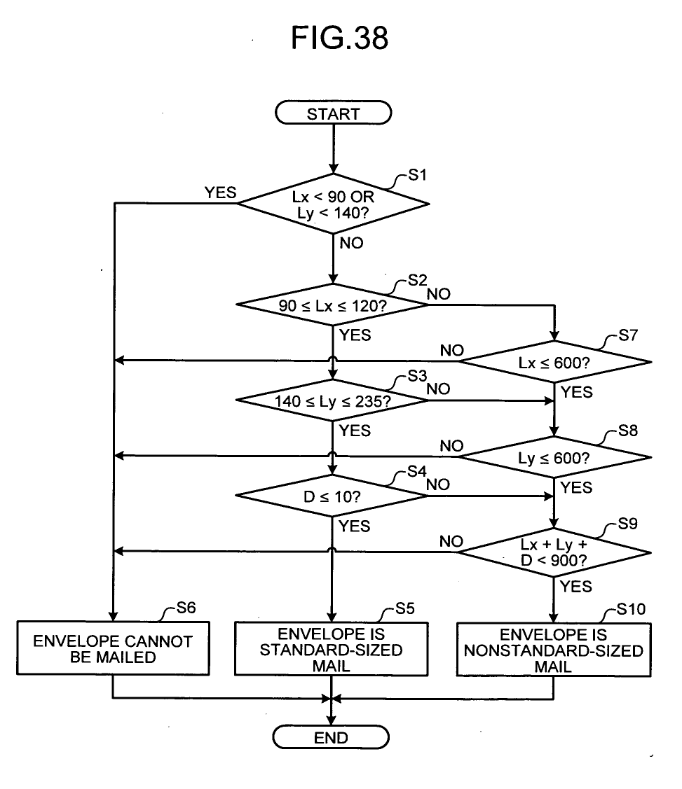

Referring to FIG. 38, a process of calculating the postage of the paper enclosed envelope will be described. The flowchart of FIG. 38 is a standard-sized/nonstandard-sized mail (hereinafter, referred to as “postal system”) determining flowchart to calculate the postage of the paper enclosed envelope.

Hereinafter, a method that calculates the postage of the paper enclosed envelope by the function as the mail postage calculating unit of the main control board 130 in the control device 120, on the basis of signals related to the size measurement result of the envelope from each size detecting sensor 32 and the CISs 201 and 202 of the size measuring device 200, a signal related to the weight measurement result of the paper enclosed envelope from the load cell 222 of the weight measuring device 220, and a signal related to the thickness measurement result of the paper enclosed envelope from the electronic micrometer 231 of the thickness measuring device 230, will be described.

Since the postal system of the envelope in the current Japanese mail is different according to the standard-sized mail and the nonstandard-sized mail, the postal system is first determined in the main control board 130. The maximum size that is allowed as the standard-sized mail is the long side 235 mm×the short side 120 mm×the thickness 10 mm and the minimum size that is allowed as the standard-sized mail is the long side 140 mm×the short side 90 mm. In addition, the maximum size that is allowed as the nonstandard-sized mail is the long side 600 mm and the long side+the short side+the thickness=900 mm, and the minimum size that is allowed as the nonstandard-sized mail is the long side 140 mm×the short side 90 mm.

In FIG. 38, the lateral length of Lx (mm) and the longitudinal length of Ly (mm) based on the size measurement result of the envelope obtained by the CISs 201 and 202 of the size measuring device 200 are used as the size of the envelope, and the calculation result D (mm) based on the thickness measurement result of the electronic micrometer 231 of the thickness measuring device 230 is used as the thickness of the paper enclosed envelope.

In step S1 of FIG. 38, first, it is checked whether the lateral length Lx (mm) and the longitudinal length Ly (mm) of the envelope are more than the minimum size allowed as the standard-sized mail (hereinafter, referred to as “standard-sized mail”), that is, Lx<90 and Ly<140 is satisfied. When the check result is NO, the process proceeds to step S2, and it is checked whether the lateral length Lx (mm) of the envelope is between the maximum size and the minimum size as the standard-sized mail, that is, 90≦Lx≦120 is satisfied. When the check result is YES, the process proceeds to step S3, and it is checked whether the longitudinal length Ly (mm) of the envelope is between the maximum size and the minimum size allowed as the standard-sized mail, that is, 140 Ly≦235 is satisfied. When the check result is YES, the process proceeds to step S4. Finally, it is checked whether the thickness D (mm) of the envelope is in the thickness range allowed as the standard-sized mail, that is, D≦10 is satisfied. In this case, when the check result is YES, finally, the envelope is determined as the standard-sized mail (step S5).

Meanwhile, in step S1, when the lateral length Lx (mm) or the longitudinal length Ly (mm) of the envelope are smaller than the minimum size allowed as the standard-sized mail, it is determined that the envelope cannot be mailed (step S6).

In step S2, when the lateral length Lx (mm) of the envelope is not between the maximum size and the minimum size allowed as the standard-sized mail, the process proceeds to step S7. It is checked whether the lateral length Lx (mm) of the envelope is within the maximum size allowed as the nonstandard-sized mail (hereinafter, referred to as “nonstandard-sized mail”), that is, Lx≦600 is satisfied. In this case, when the check result is YES or when the check result is NO in step S3, the process proceeds to step S8, and it is checked whether the longitudinal length Ly (mm) of the envelope is within the maximum size allowed as the nonstandard-sized mail, that is, Ly≦600 is satisfied. In this case, when the check result is YES or when the check result is NO in step S4, the process proceeds to step S9. It is checked whether a total sum of the lateral length Lx (mm), the longitudinal length Ly (mm), and the thickness D (mm) of the envelope is within a range allowed as the standard-size mail, that is, Lx+Ly+D<900 is satisfied. In this case, when the check result is YES, the envelope is determined as the nonstandard-sized mail (step S10).

When the check result is NO in step S7, the check result is NO in step S8 or the check result is NO in step S9, the envelope does not correspond to the nonstandard-sized mail. Therefore, it is determined that the envelope cannot be mailed (step S6).

According to the result obtained by the flowchart of FIG. 38, the postal system is determined. In this case, when it is determined that the “envelope cannot be mailed”, that is, when the calculation of the postage by the main control board 130 (CPU 131: postage calculating unit) is disabled, this is displayed on the display section 104 (third notifying unit or the third display unit) of the copy machine 1 functioning as the image forming apparatus to notify the user. The third notifying unit and the third display unit may be disposed in the SSP device 3 (postprocessing device), not in the copy machine 1 (image forming apparatus).

Next, the specific postage is calculated. In the ROM 132 of the main control board 130, a postal system-specific postage table such as shown in the following table 1 is stored in advance. The postage table becomes a matrix table that uses each postal system and each weight as parameters. In the postage table, a relationship of each postal system and each weight is stored as a data table. The weight of the paper enclosed envelope is calculated by using the calculation result VL based on the weight measurement result obtained by the load cell 222 of the weight measuring device 220 described above. In this way, the charge of the paper enclosed envelope can be calculated.

TABLE 1

Postage [yen]

| Weight | Standard- | Nonstandard- |
|---|---|---|
| [g] | sized mail | sized mail |
| To 25 | 80 | 120 |
| To 50 | 90 | 120 |
| To 100 | → | 140 |
| To 150 | → | 200 |
| To 250 | → | 240 |
| To 500 | → | 390 |
| To 1000 | → | 580 |
| To 2000 | → | 850 |
| To 4000 | → | 1150 |

As shown in Table 1, Even though the size is the standard-sized mail size, when the weight exceeds 50 g, the postage becomes the same as the nonstandard-sized mail. Therefore, in this embodiment, even though the mail is determined as the standard-sized mail based on the size, when the postage is determined as that of the nonstandard-sized mail based on the weight, this can be displayed on the display section 104 of the copy machine 1 to inform the user.

The measured weight is displayed on the display section 104 of the copy machine 1. Therefore, the user can know the weight data of the mail that becomes the basis of the postage data.

The finally calculated postage is displayed on the display section 104 of the copy machine 1. Therefore, the user can know the postage by viewing the postage displayed on the display section 104.

As described above, according to the embodiment described above, the following advantages or effects can be achieved.

First, the image forming device (copy machine 1) functioning as the image forming unit to form an image on the paper (sheet) including the envelope corresponding to the mail, the size detecting sensor 32 functioning as the size recognizing unit to recognize the size of the mail on which the image is formed by the copy machine 1, the size detecting device 30, the CISs 201 and 202 of the size measuring device 200, the load cell 222 of the weight measuring device 220 functioning as the weight recognizing unit to recognize the weight of the mail, the electronic micrometer 231 of the thickness measuring device 230 functioning as the thickness recognizing unit to recognize the thickness of the mail, and the main control board 130 of the control device 120 functioning as the postage calculating unit to calculate the postage of the mail, on the basis of the signals output from the size detecting sensor 32, the size detecting device 30, the CISs 201 and 202, the load cell 222, and the electronic micrometer 231 are provided so that the postage of the mail can be calculated with high precision.

Second, the SSP unit 40 that includes the enclosing unit (envelope chuck section 45 and the pack unit 46) that encloses at least one paper (sheet) in the envelope is provided so that the postage of the envelope (mail) in which at least one paper (sheet) is enclosed can be calculated with high precision.

Third, when the mail is the postcard, the postage of the postcard (mail) can be calculated with high precision.

Fourth, since the weight recognizing unit is the load cell 222 functioning as the weight measuring unit to measure the weight of the mail, the weight of the mail such as the paper enclosed envelope, the postcard, etc. can be automatically measured by the weight measuring unit, without need of setting of the weight of the mail by the user. Therefore, convenience with respect to the user can be improved and the postage can be accurately calculated.

Fifth, the display section 104 that functions as the first notifying unit to notify the postage calculated by the main control board 130 of the control device 120 functioning as the postage calculating unit is provided so that the user can know the postage.

Sixth, the display section 104 that functions as the second notifying unit to notify the weight data automatically measured by the load cell 222 functioning as the weight measuring unit is provided so that the user can know the weight data of the mail.

Seventh, the display section 104 that functions as the third notifying unit to notify that the postage cannot be calculated by the main control board 130 of the control device 120 functioning as the postage calculating unit is provided so that the user can know that the mail cannot be mailed, for example, when the size of the mail is excessively small or large.

Eighth, since the CISs 201 and 202 in the size measuring device 200 are included as the two size measuring units, the longitudinal and lateral sizes of the envelope can be accurately calculated. Further, the paper size can be accurately calculated by including two CISs in each of other trays.

First Modification

Hereinafter, the first modification of the embodiment when the mail is a “postcard” or a “return postcard” will be described. In the embodiment, the specific example based on the envelope is described. However, the postage of the postcard or the return postcard can be calculated by the same mechanism and configuration.

An example of the case of the postcard will be described. First, the postcard is set to the feed cassette 15A of the feed section 11 and then the main control board 130 automatically recognizes and determines that the size in the feed cassette 15A is the postcard size, on the basis of the output signal from the size detecting sensor 32. Then, instead of feeding the envelope, the postcard is fed. In a flow that is the same as that described in the aforementioned embodiment but in which the “envelope” is replaced with the “postcard”, the weight of the postcard can be calculated.

The weight (VL) of the postcard can be calculated in the same flow described in the embodiment, except that the operation for enclosing the paper in the envelope is not executed, which is a different point from the flow and the operation described in the aforementioned embodiment, which is caused because of the case of the postcard.

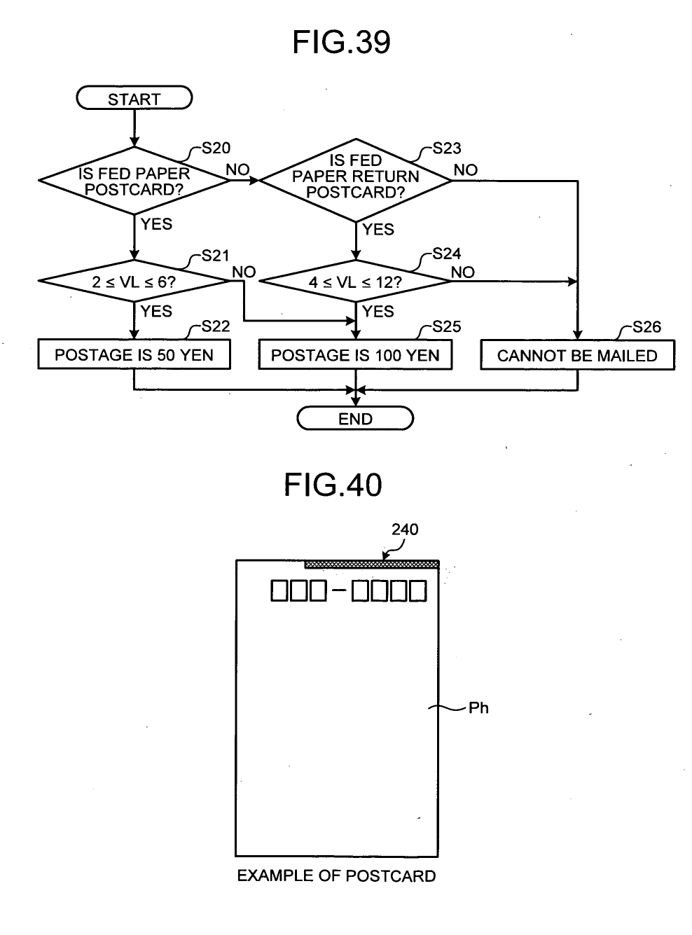

Since the size and the weight can be known, as illustrated in the flowchart of FIG. 39, the charge can be calculated (refer to steps S20 to S26). In steps S21 and S24, the weight range that is allowed as the “postcard” of the mail is from 2 g to 6 g and the weight range that is allowed as the “return postcard” is from 4 g to 12 g. In step S26, when the “mailing is disabled”, this is displayed on the display section 104 of the copy machine 1 to inform the user, in the same way as that described in the embodiment.

In this case, instead of the configuration where the size detecting sensor 32 detects whether the mail is the postcard or the return postcard, it is possible to configure to be able to perform setting that indicates that the mail is the postcard or the return postcard, similar to the configuration in which the paper size is instructed or set, for example, using the operation panel 100.

In the weight measurement based on the load cell 222 of the weight measuring device 220, for example, when the sensitivity of the load cell 222 is 20 mg, for enabling the accurate measurement from 2 g to 4000 g, plural load cells having the different sensitivity and the envelope fences for the plural load cells may be attached to the belt 226 of the vertical moving mechanism 223 shown in FIGS. 28A to 28C and 31 at different positions along the traveling direction, and the weight may be measured while changing the used load cell as needed.

As described above, although redundant explanation is omitted, even in the case of the postcard and the return postcard, the same advantages and effects as the case of the envelope can be achieved.

Hereinafter, various modifications of the embodiment will be described.

The invention is not limited to the embodiment and the first modification. In the image forming system according to any one of the embodiment and the first modification, the postage table with respect to the weight data, the size, and the thickness may be configured to be able to be changed freely by the user (second modification).

According to the second modification, for example, by changing the threshold value 100 g of the weight data of the nonstandard size to 98 g, the user can set a safety factor of 2% and reliability of the postage can be improved.

As the configuration/unit that allows the user to freely change the postage table, for example, in addition to the ROM 132 of the main control board of FIG. 37, a PROM (EPROM, EEPROM, flash memory, etc.) in which the data table can be rewritten may be provided, and a so-called service program or serviceman program that enables setting of rewrite data from the operation panel, etc. is used.

The invention is not limited to the embodiment and the modifications. In the image forming system according to any one of the embodiment and the modifications, a feature whereby the plural postage tables with respect to the weight data, the size, and the thickness can be changed freely by the user may be employed (third modification).

According to the third modification, the user can have the two postage tables of the data of the safety factor of 2% and the default data.

The invention is not limited to the embodiment and the modifications. In the image forming system according to the third modification, a feature whereby a postage table composed of the default data of the weight data, the size, and the thickness is stored may be employed (fourth modification).

According to the fourth modification, a configuration in which a default charge table set by the user is selected from some postage tables when the power supply is turned on can be obtained.

The invention is not limited to the embodiment and the modifications. In the image forming system according to the fourth modification, a feature whereby a selecting unit to return the postage table with respect to the weight data, the size, and the thickness to the postage table to the default table is provided may be employed (fifth modification).

According to the fifth modification, a countermeasure against a case where the user processes the postage table and then cannot return that postage table to the original postage table can be easily executed.

The invention is not limited to the embodiment and the modifications. In the image forming system according to any one of the embodiment and the modifications, a feature whereby the postage tables with respect to the weight data, the size, and the thickness are stored for respective nations may be employed (sixth modification).

According to the sixth modification, since the postage table is different for each nation, an image forming system that has the postage tables for respective nations and thus usable regardless shipping address can be configured.

The invention is not limited to the embodiment and the modifications. In the image forming system according to the sixth modification, a feature whereby the postage data is selected on the basis of shipment address data stored in the image forming system may be employed (seventh modification).

According to the seventh modification, the image forming device can set default value of the postage data to itself according to a setting of the shipment address without requiring the user to make selection.

The invention is not limited to the embodiment and the modifications. In the image forming system according to any one of the embodiment and the modifications, a feature whereby the image forming system has a fourth notifying, unit to notify that the postage is approximated to a threshold value, when a threshold value where the postage changes is set to the weight data M, the size S, and the thickness D and the image forming system detects information of any of M±α, S±β, and D±γ (eighth modification). In this context, α, β, and γ are variable.

In the second modification, the safety factor can be set freely by the user. However, in the eighth modification, the image forming system stores the safety factor with respect to M, S, and D. When the safety factor is exceeded, this can be displayed, e.g., on the display section 104 of the copy machine 1 of FIG. 1 constituting the image forming device by the image forming system to inform the user.

The fourth notifying unit or the fourth display unit may be disposed in the SSP device 3 (postprocessing device), not in the copy machine 1 (image forming device).

The invention is not limited to the embodiment and the modifications. In the image forming system according to the eighth modification, a feature whereby α, β, and γ can be changed freely (arbitrarily) by the user may be employed (ninth modification).

According to the ninth modification, the safety factor may be arbitrarily changed by the user.

The invention is not limited to the embodiment and the modifications. In the image forming system according to any one of the embodiment and the modifications, a feature whereby the image forming system has a destination setting unit to set destination information and a forwarding method setting unit to set a forwarding method, and the postage calculating unit (main control board 130) calculates the postage on the basis of signals output from the destination setting unit and the forwarding method setting unit (tenth modification).

According to the tenth modification, the user sets the destination and the forwarding method using, for example, the operation panel 100 of the copy machine 1 corresponding to the image forming device, and the international postage can be calculated on the basis of postage table data that is stored in the ROM 132 of the main control board 130 and is shown in the following table 2.

For example, the table 2 shows a postage table according to each destination and each forwarding method in Japan. Each destination of foreign countries is shown in the following table 3.

TABLE 2

| | Postage [yen] | | | |
|---|---|---|---|---|
| | First zone | | | |
| | Ship mail | | Air mail | |
| Weight | Standard- | Nonstandard- | Standard- | Nonstandard- |
| [g] | sized mail | sized mail | sized mail | sized mail |
| To 20 | 90 | ← | 90 | 220 |
| To 50 | 160 | ← | 160 | 220 |
| To 100 | 270 | ← | → | 330 |
| To 250 | 540 | ← | → | 510 |
| To 500 | 1040 | ← | → | 780 |
| To 1000 | 1800 | ← | → | 1450 |
| To 2000 | 2930 | ← | → | 2150 |
| | Postage [yen] | | | |
| | Second zone | | | |
| | Ship mail | | Air mail | |
| Weight | Standard- | Nonstandard- | Standard- | Nonstandard- |
| [g] | sized mail | sized mail | sized mail | sized mail |
| To 20 | 90 | ← | 110 | 260 |
| To 25 | 90 | ← | 110 | 260 |
| To 50 | 160 | ← | 190 | 260 |
| To 100 | 270 | ← | → | 400 |
| To 250 | 540 | ← | → | 670 |
| To 500 | 1040 | ← | → | 1090 |
| To 1000 | 1800 | ← | → | 2060 |
| To 2000 | 2930 | ← | → | 3410 |
| | Postage [yen] | | | |
| | Third zone | | | |
| | Ship mail | | Air mail | |
| Weight | Standard- | Nonstandard- | Standard- | Nonstandard- |
| [g] | sized mail | sized mail | sized mail | sized mail |
| To 20 | 90 | ← | 130 | 300 |
| To 25 | 90 | ← | 130 | 300 |
| To 50 | 160 | ← | 230 | 300 |
| To 100 | 270 | ← | → | 480 |
| To 250 | 540 | ← | → | 860 |
| To 500 | 1040 | ← | → | 1490 |
| To 1000 | 1800 | ← | → | 2850 |
| To 2000 | 2930 | ← | → | 4990 |

TABLE 3

| First Zone | | Second Zone | Third Zone |
|---|---|---|---|
| American | | Australia | Argentina |
| | Wake Island | Kiribati | Uruguay |
| | Northern | Samoa | Ecuador |
| | Mariana | | |
| | Islands | | |
| | Guam | Solomon | Guyana |
| | Midway | Tuvalu | Colombia |
| | Islands | | |

| | | |
|---|---|---|
| North Korea | Tonga | Suriname |
| South Korea | Nauru | Chile |
| Taiwan | New Caledonia | Paraguay |
| China | New Zealand | Falkland Islands |
| | | (Islas Malvinas) |
| Palau | Vanuatu | French Guiana |
| Philippines | Papua New Guinea | Brazil |
| Hong Kong | Pitcairn Island | Venezuela |
| Marshall | Fiji | Peru |
| Macau | French Polynesia | Bolivia |
| Micronesia | other Isles of Oceania | Ascension |
| Mongol | America | Algeria |
| Afghanistan | American territory | Angola |

| | | |
|---|---|---|
| India | Puerto Rico | Uganda |
| Indonesia | U.S. Virgin Islands | Egypt |

| | | |
|---|---|---|
| Cambodia | Anguilla | Ethiopia |
| Singapore | Antigua and Barbuda | Eritrea |
| Sri Lanka | British Virgin Islands | Ghana |
| Thailand | El Salvador | Cape Verde |
| Nepal | Netherlands Antilles | Gabon |
| | and Aruba | |
| Pakistan | Guadeloupe | Cameroon |
| Bangladesh | Canada | Gambia |
| East Timor | Cuba | Guinea |
| Bhutan | Guatemala | Guinea Bissau |
| Brunei | Grenada | Kenya |
| Vietnam | Cayman Islands | Cote d'Ivoire |
| Malaysia | Costa Rica | Comoros |
| Myanmar | Saint Pierre and | Republic of the Congo |
| | Miquelon | |
| Maldives | Jamaica | Democratic Republic of |
| | | the Congo |
| Laos | Saint Vincent | Sao Tome and Principe |
| | Saint Christopher and | Zambia |
| | Nevis | |
| | Saint Lucia | Sierra Leone |
| | Turks and Caicos | Djibouti |
| | Islands | |
| | Dominica | Zimbabwe |
| | Dominican Republic | Sudan |
| | Trinidad and Tobago | Swaziland |
| | Nicaragua | Seychelles |
| | Haiti | Equatorial Guinea |
| | Panama | Senegal |
| | Bahamas | Saint Helena |
| | Bermuda islands | Somalia |
| | Barbados | Tanzania |
| | Belize | Chad |
| | Honduras | Central African |
| | Martinique | Tunisia |
| | Mexico | Togo |
| | Montserrat | Tristan da Cunha |
| | United Arab Emirates | Nigeria |
| | Yemen | Namibia |
| | Israel | Niger |
| | Iraq | Burkina Faso |
| | Iran | Burundi |
| | Oman | Benin |
| | Qatar | Botswana |
| | Cyprus | Madagascar |
| | Kuwait | Malawi |
| | Saudi Arabia | Mali |
| | Syria | South African Republic |
| | Turkey | Mauritius |
| | Bahrain | Mauritania |
| | Jordan | Mozambique |
| | Lebanon | Morocco |
| | Iceland | Libya |
| | Ireland | Liberia |
| | Azerbaijan | Rwanda |
| | Albania | Lesotho |
| | Armenia | Reunion |
| | Andorra | |
| | Italy | |
| | Ukraine | |

The invention is not limited to the embodiment and the modifications. In the image forming system according to the tenth modification, a feature whereby the destination information is only a forwarding zone may be employed (eleventh modification).

According to the eleventh modification, since only the name of a country is used and an address is not needed, setting can be simplified.

The invention is not limited to the embodiment and the modifications. In the image forming system according to any one of the embodiment and the modifications, a feature whereby the image forming system has a generated copy number setting unit to set the number of generated copies of the mail and the postage calculating unit (main control board 130) calculates the postage, on the basis of a signal output from the generated copy number setting unit (twelfth modification).

As the generated copy number setting unit, the ten key 105 and the enter key 107 of the operation panel 100 according to the embodiment are exemplified.

When the number of generated copies set by the generated copy number setting unit is large, the potage can be discounted. Therefore, the discounted postage MO×α1 is calculated by multiplying the calculated postage MO by a correction factor α1. A relationship of the correction factor α1 and the generated copy number is shown in the following table 4. The table 4 is previously stored as a data table in the ROM 132 of the main control board 130.

TABLE 4

| Generated copy number | α1 |
|---|---|
| 1000 to | 0.9 |
| 3000 to | 0.85 |
| 5000 to | 0.8 |

The invention is not limited to the embodiment and the modifications. In the image forming system according to any one of the embodiment and the modifications, a feature whereby the image forming system has an express delivery recognizing unit to recognize whether a mail is an express delivery, and the postage calculating unit (main control board 130) calculates the postage of the mail on the basis of a signal indicating information regarding the express delivery output from the express delivery recognizing unit (thirteenth modification).

The express delivery recognizing unit includes an express delivery detecting unit that detects whether a mail is the express delivery and an express delivery setting unit that sets that a mail is the express delivery. The express delivery detecting unit comprises, for example, a reflective photo sensor that can recognize/detect a red color. As the express delivery setting unit, a dedicated key (not shown in the drawings) that is provided, for example, in the operation panel 100 is exemplified.

In the case of the express delivery, the postage of the total sum is calculated by adding the express delivery charge to the postage shown in the table 1. The corrected postage MO+α2 is calculated by adding the express delivery charge α2 to the calculated postage MO. A relationship of the express delivery charge α2 and the weight is shown in the following table 5.

According to the thirteenth modification, the postage of the express mail can be calculated.

TABLE 5

Postage α2 [yen]

| Weight | Standard- | Nonstandard- |
|---|---|---|
| [g] | sized mail | sized mail |
| To 250 | 270 | ← |
| To 1000 | 370 | ← |
| To 4000 | 630 | ← |

The invention is not limited to the embodiment and the modifications. In the image forming system according to the thirteenth modification, a feature whereby the image forming unit (copy machine 1) is configured to perform the express delivery marking on the mail and performs the express delivery marking on the mail, on the basis of the signal indicating information regarding the express delivery output from the express delivery recognizing unit (fourteenth modification).

The copy machine 1 may be configured to perform the express delivery marking on the mail such as the envelope or the postcard, that is, at least express delivery dedicated red line printing. In the fourteenth modification, a color image forming device that can form an image with plural colors including at least a red color is preferably used.

As shown in FIG. 40, when it is recognized in the image forming device (copy machine 1) that postcard Ph (or envelope) is intended to be mailed by express is recognized, the red line that is the express delivery mark 240 is printed on the postcard Ph (or envelope). In addition, the “express delivery” may be printed with the red color.

According to this modification, since the express delivery marking can be automatically performed on the express mail, convenience for the user can be improved.

The invention is not limited to the embodiment and the modifications. In the image forming system according to the thirteenth modification or the fourteenth modification, a feature whereby the image forming system has an express delivery marking selection unit to select whether the express delivery marking is performed may be employed (fifteenth modification).

When the envelope or the postcard is used exclusively for the express delivery and the read line is already marked, dedicated printing is not needed. Therefore, the fifteenth modification is configured to allow the user to select whether the dedicated printing should be performed using the express delivery marking selecting unit. As the express delivery marking selecting unit, a dedicated key (not shown in the drawings) that is provided, for example, in the operation panel 100 is exemplified.

For example, when the envelope or the postcard is made exclusively for the express delivery and is previously marked with the red line, the express delivery marking is not needed. Thus, according to this modification, the image forming system has the express delivery marking selecting unit to select whether the express delivery marking should be performed so that the user can select them freely.

The invention is not limited to the embodiment and the modifications. In the image forming system according to any one of the tenth modification to the fifteenth modification, a feature whereby the image forming system has a selecting unit to select whether the destination setting unit, the generated copy number setting unit, and the express delivery recognizing unit should be used to calculate the postage (sixteenth modification).

The international mail, the discount based on the generated copy number, and the express delivery are used, only when necessary. According to the sixteenth modification, a selection button that functions as the selecting unit to select whether the international mail, the discount based on the generated copy number, and the express delivery should be enabled is prepared in the operation panel 100 of the image forming device (copy machine 1), and the user does not need to set unnecessary data.

The invention is not limited to the embodiment and the modifications. In the image forming system according to the sixteenth modification, a feature whereby whether the destination setting unit, the generated copy number setting unit, and the express delivery recognizing unit should be enabled is set as “NO” by default (seventeenth modification).

In the seventeenth modification, the selection button of the international mail, the discount based on the generated copy number in the sixteenth modification and the express delivery is set as “DISABLE” by default.

The invention is not limited to the embodiment and the modifications. In the image forming system according to any one of the embodiment and the modifications, a feature whereby the postage data can be acquired and updated through a LAN may be employed (eighteenth modification).

According to the eighteenth modification, the main control board 130 can have access to the web through the I/O interface and can always obtain the newest postage data.

The invention is not limited to the embodiment and the modifications. In the image forming system according to any one of the embodiment and the modifications, a feature whereby the image forming system has a fifth notifying unit (the display section 104 of the copy machine 1) to notify classification of the postage (postcard, letter, or envelope) may be employed (nineteenth modification).

According to the nineteenth modification, whether the classification of the postage is the standard-sized mail, the nonstandard-sized mail or the postcard is displayed on the display section 104 of the copy machine 1 so that this can be informed to the user.

The invention is not limited to the embodiment. In the image forming system according to the embodiment, a feature whereby the image forming system has plural thickness measuring units may be employed (twentieth modification).

According to the twentieth modification, the image forming system has the plural electronic micrometers 231, thus can increase the measurement positions of the thickness of the envelope, the postcard or the paper, and can remove the thickness error according to the places to improve precision.

The invention is not limited to the embodiment. In the image forming system according to the embodiment, a feature whereby the image forming system has a flap length setting unit to set the length of the flap of the envelope and a size correcting unit to correct the size of the envelope, on the basis of a signal indicating the length of the flap output from the flap length setting unit may be employed (twenty-first modification).

As the flap length setting unit, a combination of the ten key 105 and the enter key 107 that are disposed in the operation panel 100 in FIG. 36 is exemplified. However, the flap length setting unit may be a dedicated key. As the size correcting unit, the main control board 130 is exemplified.

According to the twenty-first modification, the length of the flap of the envelope (mail) is set by the user and the reliability of the size data of the envelope can be improved.

The invention is not limited to the embodiment. In the image forming system according to the embodiment, a feature whereby the image forming system has a storage unit that stores the size of the envelope and the length of the flap of the envelope (twenty-second modification).

As the storage unit, the ROM 132 described above is exemplified.

According to the twenty-second modification, the size of the envelope and the length of the flap of the envelope are stored, the user does not need to set/input the flap length as in the twenty-first modification, and convenience can be improved.

The invention is not limited to the embodiment and the modifications. In the image forming system according to any one of the embodiment and the modifications, a feature whereby the image forming system has a sixth notifying unit to notify the plural mailing methods (twenty-third modification).

As the sixth notifying unit, similar to the example described above, the display section 104 that functions as the display unit disposed in the copy machine 1 is exemplified.

An EXPACK500 where a standard-sized package (size after a reception opening is sealed is equal to or less than the length 340 mm×the width 248 mm) is used in the exterior of a baggage is used as a mail delivery system. In the EXPACK500, the dedicated envelope (248 mm×340 mm or less) described above is used, and the weight until 30 kg can be mailed at a cost of 500 yen. Therefore, it may be economical to use the EXPACK500 according to the condition. The two methods of the common mailing and the EXPACK500 are displayed on the display section 104 of the copy machine 1 that functions as the image forming device and is shown in FIG. 1, and the user can select the cheaper mailing method.

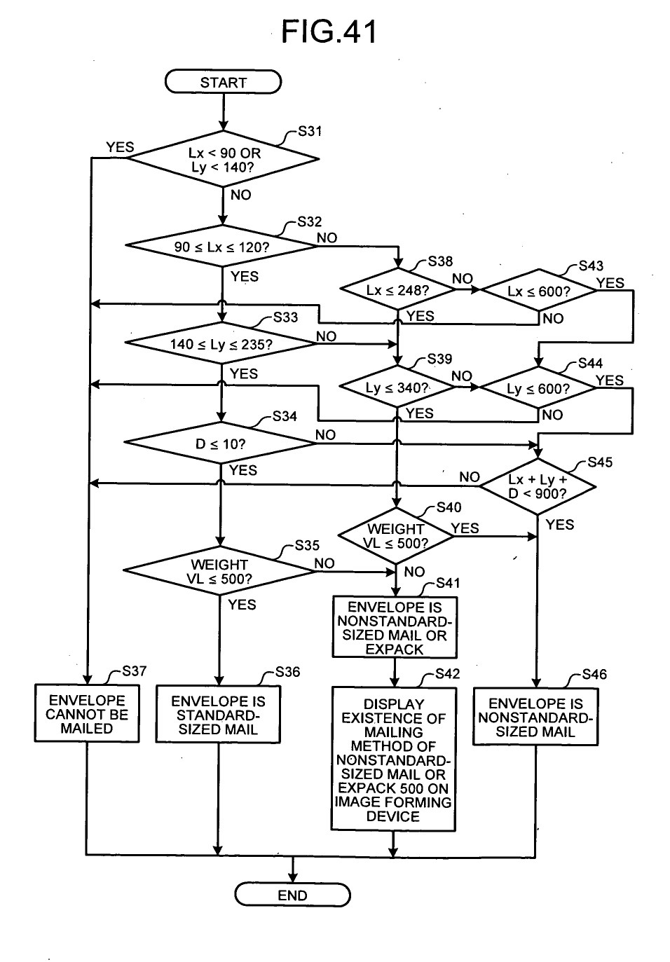

FIG. 41 shows a flow of determination of a mailing system to calculate the postage, when the EXPACK500 is added. In FIG. 41, steps S31 to S34 are the same as steps S1 to S4 shown in FIG. 38 and steps S43 to S46 are the same as steps S7 to S10 shown in FIG. 38.

According to the postages depending on weight shown in the table 1 described above, in the standard-sized mail and the nonstandard-sized mail, if the weight (g) is 500 g or more, the postage is 580 yen. However, in the EXPACK500, the postage is 500 yen until the weight of 30 kg. From this viewpoint, in steps S35 and S40, the weight VL≦500 is checked. In order to check the size of the dedicated envelope (248 mm×340 mm or less), checking on the longitudinal length of the envelope Lx≦248 in step S38 and checking on the lateral length of the envelope Lx≦340 in step S39 are performed.

In steps S35 and S40, when the weight VL≦500 is satisfied, the process proceeds to step S41 and it is determined that the envelope can be mailed as the nonstandard-sized mail or the EXPACK500. In step S42, information indicating that the possible mailing method is the nonstandard-sized mail or the EXPACK500 is displayed on the image forming device (for example, display section 104 of the copy machine 1 shown in FIG. 1).

As described above, the essential configuration of the image forming system according to the embodiment to resolve the above problems includes the image forming unit that forms an image on the sheet including the mail; at least the size recognizing unit that recognizes the size of the mail on which the image is formed by the image forming unit among the size recognizing unit, the weight recognizing unit that recognizes the weight of the mail, and the thickness recognizing unit that recognizes the thickness of the mail; and the postage calculating unit that calculates the postage of the mail, on the basis of a signal output from at least the size recognizing unit.

The enclosing unit is generally disposed in the postprocessing device. However, in the essential configuration described above, the enclosing unit may be included integrally in the image forming device that functions as the image forming unit.

According to the present invention, a novel image forming system to solve the above problems can be realized and provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming system, comprising:
an image forming unit that forms an image on a sheet including a mail;
a size recognizing unit that recognizes a size of the mail on which the image is formed by the image forming unit; and
a postage calculating unit that calculates the postage of the mail, on the basis of a signal output from the size recognizing unit.

2. The image forming system of claim 1, further comprising:
a weight recognizing unit that recognizes a weight of the mail; and
a thickness recognizing unit that recognizes a thickness of the mail,
wherein the postage calculating unit that calculates the postage of the mail, also on the basis of a signal output from the weight recognizing unit and the thickness recognizing unit.

3. The image forming system of claim 1,
wherein the mail is an envelope in which at least one sheet is enclosed, and
the image forming system further comprises an enclosing unit that encloses at least one sheet in the envelope.

4. The image forming system of claim 1,
wherein the mail is a postcard.

5. The image forming system of claim 2,
wherein the weight recognizing unit is a weight measuring unit that measures a weight of the mail.

6. The image forming system of claim 1, further comprising:
a first notifying unit that notifies the postage calculated by the postage calculating unit.

7. The image forming system of claim 2, further comprising:
a second notifying unit that notifies weight data recognized by the weight recognizing unit.

8. The image forming system of claim 1, further comprising:
an express delivery recognizing unit that recognizes whether the mail is an express delivery,
wherein the postage calculating unit calculates the postage of the mail, on the basis of a signal indicating information regarding the express delivery output from the express delivery recognizing unit.

9. The image forming system of claim 8,
wherein the image forming unit is configured to perform express delivery marking on the mail, and
the image forming unit performs the express delivery marking on the mail, on the basis of the signal indicating information regarding the express delivery output from the express delivery recognizing unit.

10. The image forming system of claim 8, further comprising:
an express delivery marking selecting unit that selects whether to perform the express delivery marking.

11. The image forming system of claim 1, further comprising:
a third notifying unit that notifies when the postage cannot be calculated by the postage calculating unit.

12. The image forming system of claim 3, further comprising:
a flap length setting unit that sets a length of a flap of the envelope; and
a size correcting unit that corrects the size of the envelope, on the basis of a signal indicating the length of the flap output from the flap length setting unit.
